(19) United States
(12) Patent Application Publication
(10) Pub. No.: US 2009/0309733 A1
(43) Pub. Date: Dec. 17, 2009

(54) IDENTIFICATION TAGS, OBJECTS ADAPTED TO BE IDENTIFIED, AND RELATED METHODS, DEVICES AND SYSTEMS

(75) Inventors: Peter Malcolm Moran, Singapore (SG); Adrian Paul Burden, Padova (IT)

Correspondence Address: FOLEY AND LARDNER LLP;SUITE 500, 3000 K STREET NW, WASHINGTON, DC, 20007, US

(73) Assignee: Singular ID Pte Ltd

(21) Appl. No.: 12/300,256

(22) PCT Filed: May 11, 2006
(86) PCT No.: PCT/SG2006/000160

§ 371 Date: Apr. 21, 2009

(51) Int. Cl. G08B 13/14

(52) U.S. Cl. 340/572.1

(57) ABSTRACT

An identification tag for identifying an object to which the identification tag may be attached or in which the tag may be embedded, as well as to objects that are adapted to be identified. The invention also relates to reading devices for reading identification features that are located in an identification tag. The tags and objects may consist of an engagement track or accommodating recess wherein the engagement track or accommodating recess is designed such that it allows reading of identification features comprised in the tag or object and wherein the engagement track or accommodating recess is designed such that it is essentially complementary in shape to an engagement element of a reading device, wherein the engagement element comprises a reading element adapted for reading the identification features located in the identification tag or object. The identification tag may also comprise an accommodating layer which comprises an accommodating recess.

The present invention relates to identification tags for identifying an object to which the identification tag may be attached or in which the tag may be embedded, as well as to objects that are adapted to be identified. The invention also relates to reading devices for reading identification features that are located in an identification tag or an object of the invention, to respective identification systems as well as to methods for reading identification features located in an identification tag or object as described here.

Identification technology has been an area of widespread interest and development for many years. Common methods of identification rely on the use of readable tags. Such tags range from serial numbers, holograms and machine-readable tags (such as barcodes, magnetic stripes and Radio Frequency Identification (RFID) chips) on the visible scale, to fluorescent inks and micron-sized scattered particles at microscopic scales.

One of the main reasons for the continued interest in identification technology is the incidence of fraud largely attributable to transactions which have been carried out in a non-secure manner. The need for more secure systems of transactions is apparent. For example, there is a need to reliably authenticate personal documents such as passports, certificates, work permits, visas and driver's licenses as well as commercial instruments such as ATM cards, credit cards, currency, cheques and other instruments of commercial transactions at the point of transaction. In another example, it would be extremely beneficial to the software and entertainment industries to be able to uniquely fingerprint items such as compact discs (CDs) and digital versatile disks (DVDs) to prevent the use of pirate copies. In yet another example, where articles of great commercial value, such as precious stones, artwork, and antiques, are transacted, it is vital that the party receiving such articles is able to ascertain the identity of the articles before issuing credit. At a more common level, there is also a need for an inexpensive and reliable authentication system for any physical object that needs to have its identity verified subsequently. Commercially, this facilitates ‘brand protection’.

Several methods of identification are known and are described in the following.

A well-known identification method relies on information encoded in a magnetic stripe, also known as a magnetic barcode, as found on a credit card. A magnetic stripe is typically made up of small magnetic particles set in a resin. The particles are either applied directly to the card or made into a stripe on a plastic backing which is applied to the card. The stripe is encoded by having regions of these particles (e.g. iron particles) magnetized in a particular direction, i.e. polarity of the magnetic particles in the stripe is changed locally, to define bits of information. By changing the direction of the encoding along the length of the stripe, information is written and stored on the stripe. Thus, identification information such as a user account number is first programmed into the magnetic stripe by a write head, and subsequently verified by reading the magnetic stripe with a read head. The user is then verified by having the user sign a document or chit, for example, or enter a personal identification number, to verify the user's identity.

Such systems are inherently non-secure because the signature and data encoded in the magnetic stripe can be forged easily. Furthermore, the magnetic media is prone to corruption when the magnetic stripe is brought into close proximity with magnetic fields.

In the following, prior art in the field of identification devices will be mentioned.

European patent application EP 0 824 242 A2 describes random magnetic rods, fibres or filaments lying on the surface of an article, the positions of which are then read and used to provide a unique signature.

U.S. Pat. No. 4,682,794 discloses a credit card made with a number of optical fibres sandwiched in the card. The fibres intersect opposite edges of the card in a random fashion to provide a unique signature of the card when light is directed into one edge, transmitted through the fibres and detected at the other edge of the card. The international patent application WO 87/06041 describes essentially the same approach as it discloses an object such as a bank note in which continuous optical fibres are incorporated, wherein these optical fibres have two end surfaces which are placed at an edge of the object. For verification of the identity of the object, also the object of WO 87/06041 is thus illuminated from one end point of the fibres and the light that travels through the optical fibres is read from the second end surface. The British patent application GB 2 099 756 describes a telephone debit card in which optical fibres are embedded in an insulating plastic material. The optical fibres extend between two edges of the card as light transmitted through the fibres is used for validation of the card, for example.

US patent application 2001/0010333 describes measuring the effect of light guided through credit cards and other planar/laminated structures and detecting the unique pattern that emerges at the edge of the item. This reference also considers the use of predetermined patterns and random patterns of such fibres as well as the effect of light scattering from opaque and transparent regions to generate patterns for identification purposes.

U.S. Pat. No. 4,218,674 describes the measurement of random surface imperfections in materials as a means of identifying an object.

The PCT application WO 2004/013735 describes an identification means that is printed using, for example, magnetic toner. This is similar to a 2D barcode pattern, and is a means of writing security information to an object in a pixellated form, like a bitmap.

PCT application WO 87/01845 and the European Patent EP 0236 365 B1 disclose the use of microwave interrogation of random fibres as a means of creating a signal for authentication.

European patent application EP 0 696 779 A1 discloses the use of random patterns of magnetic ink printed on the surface of an object such as a credit card.

European patent EP 0 583 709 B1 discloses the random distribution of particles on a card measured over a surface by electromagnetic scanning and then the signature is linked to a memory chip on the card.

European patent EP 0 820 031 B1 discloses replacing the strip on a credit card to a card in which the whole area contains magnetic material.

The PCT application WO 03/017192 relates to magnetic fibres or filaments on the surface of an object that are interrogated using an induction read head.

US patent application 2002/0145050 relates to storing data in a magnetic stripe of a card relating to its microstructure, and linking it with biometric data.

European patent 1 031 115 B1 discloses the attachment of magnetic particle fingerprints to the surfaces of documents, and to read the signature and cross-reference it with another attached label.

U.S. Pat. No. 5,430,279 discusses methods and circuits to detect and authenticate (using a checksum approach) the magnetic jitter in magnetic stripes.

U.S. Pat. No. 4,395,628 discloses the use of microdots of magnetic material as a unique pattern that is written (e.g. using laser beam) to a card as part of its security system.

U.S. Pat. No. 4,557,550 discloses the use of two stripes, one recordable and one permanent to improve security on a card.

U.S. Pat. No. 6,254,002 B1 discloses an anti-forgery security system in the field of casino chips having randomly distributed magnetic particles attached to the surfaces and/or edge of a casino chip to form a source of magnetically readable information.

Finally, US patent application 2005017082A1 and the international patent application WO 2005/008284 describes using disordered porous materials filled with magnetic material as a unique identifier for security applications.

However, there is still a need for identification tags or objects adapted to be identified which can be read in an easy and efficient manner, which is inexpensive in production, and which provides sufficient security of verification, i.e. in which the reliability of the identification is sufficiently high.

It is an objective of the present invention to provide such tags and objects. This objective, and others, is solved by the tags, objects, and systems as defined by the respective independent claims.

In one embodiment, such a tag is an identification tag for identifying an object to which the identification tag may be attached,

said identification tag comprising an accommodating layer,

wherein said accommodating layer comprises at least one accommodating recess, wherein the accommodating recess comprises at least in part randomly distributed material, wherein said at least partly randomly distributed material forms readable identification features for identifying the object.

In a related embodiment, the invention is directed to an object having such an identification tag attached to it. The identification tag can be attached such on (an external surface of) the object so that the tag forms an engagement track on the object, wherein said engagement track is essentially complimentary in shape to a part of a reading device that reads the identification features located in the identification layer. By this arrangement, the engagement track allows easy alignment of the reading device with the identification features and thus a simple and reliable method for identifying the object to which the tag is attached.

In another embodiment a tag of the invention is an identification tag for identifying an object to which the identification tag may be attached, said identification tag comprising a cavity,

wherein readable identification features are arranged in the tag so that the identification features can be read by a part of a reading device to be inserted into the cavity for reading the identification features,

wherein the cavity is designed such that an engagement track is formed in the tag, and

wherein said engagement track is essentially complimentary in shape to the part of the reading device that reads the identification features arranged in the tag, the engagement track thereby allowing easy alignment of said part of the reading device with respect the identification features.

In yet another embodiment, a tag of the invention is an identification tag for identifying an object to which the identification tag may be attached, said identification tag comprising an identification layer,

wherein readable identification features are located in the identification layer and wherein said identification features are formed, at least in part, by randomly distributed material comprised in the identification layer, and

wherein the identification layer is arranged in the identification tag such that an engagement track is formed in the tag, wherein said engagement track is essentially complimentary in shape to a part of a reading device that reads the identification features located in the identification layer, the engagement track thereby allowing easy alignment of said part of the reading device with respect to the identification features. The engagement formed in the tag may be in the form of a protrusion or a recess. In one embodiment, in which the engagement track is formed as a protrusion, a tag is excluded, in which the thinnest dimension of the identification layer is exposed in such a manner that at least some of the readable identification features are only meaningfully readable from the thinnest dimension of the identification layer.

The present invention also refers to objects adapted to be identified.

In one embodiment such an object is an object that comprises a cavity,

wherein readable identification features are arranged such in the object that the identification features can be read by a part of a reading device to be inserted into the cavity for reading the identification features,

wherein the cavity is designed such that an engagement track is formed in the object, and

wherein said engagement track is essentially complimentary in shape to the part of the reading device that reads the identification features arranged in the object. Thereby the engagement track allows easy alignment of said part of the reading device with respect to the identification features.

Another embodiment is directed to an object that is adapted to be identified, and that comprises an identification layer,

wherein readable identification features are located in the identification layer and wherein said identification features are at least in part formed by randomly distributed material comprised in the identification layer, and

wherein the identification layer is arranged in the object such that an engagement track is formed in the object, wherein said engagement track is essentially complimentary in shape to a part of a reading device that reads the identification features located in the identification layer. Also in this embodiment, the engagement track thereby allows easy alignment of the reading device with respect the identification features.

In a related embodiment, the invention is also directed to an object having attached an identification tag (herein termed an “identification tag object”), wherein said identification tag object comprises an identification layer,

wherein readable identification features are located in the identification layer and wherein said identification features are formed at least in part by randomly distributed material comprised in the identification layer, and

wherein the identification tag is arranged on an external surface of the object such that the tag forms an engagement track on the object, wherein said engagement track is essentially complimentary in shape to a part of a reading device that reads the identification features located in the identification layer via the reading track, the engagement track thereby allowing easy alignment of the reading device with the identification features, with the proviso that the identification layer is not exposed in such a manner that at least some of the readable identification features are only meaningfully readable from the thinnest dimension of the identification layer.

In yet another embodiment the invention is directed to an object comprising an identification tag, wherein said identification tag object comprises an identification layer,

wherein readable identification features are located in the identification layer of the identification tag and wherein said identification features are formed at least in part by randomly distributed material comprised in the identification layer, and

wherein the identification tag is arranged in the object such that an engagement track in formed in the object by the object and the identification tag, wherein said engagement track is essentially complimentary in shape to a part of a reading device that reads the identification features located in the identification layer via the reading track, the engagement track thereby allowing easy alignment of the reading device with the identification features.

As can be seen from the above, the underlying concept of the invention is to provide complementarity in shape between a part of either an identification tag in which identification features are located or an object in which identification features are located (and that is therefore by itself adapted to be identified) and a part of a reading device that reads the identification features. This complementarity between the part of the object or tag, which allows access of the reader to the identification features (which part is referred to as “engagement track” herein) and the part of the reading device that comprises a reading element adapted to read the identification features (which part is referred to as “engagement element” herein) provides a close physical/mechanical interaction between engagement track and engagement element so that the reading element can be easily and reliably aligned with the identification features.

In accordance with the above, the present invention provides a variety of reading devices having a corresponding design.

One such embodiment is a reading device for reading identification features that are located in an identification tag or an object adapted to be identified,

wherein the identification tag or object comprises an engagement track formed as a cavity or recess in the tag or the object, wherein said engagement track is used to (accurately locate and) read the identification features, said reading device comprising a reading element adapted for reading the identification features located in the identification tag or object adapted to be identified,

wherein said reading element is located within an engagement element of the reading device, wherein said engagement element is essentially complementary in shape to the engagement track of the identification tag or object.

Another embodiment is a reading device for reading identification features that are located in an identification tag or an object adapted to be identified, wherein the identification tag or object comprises an engagement track formed as a protrusion in the tag or the object, wherein said engagement track is used to read the identification features,

said reading device comprising

a reading element adapted for reading the identification features located in the tag or object, wherein the reading element is located in a non-U-shaped engagement element that is essentially complementary in shape to the engagement track of the identification tag or object.

A third embodiment of a reading device is a reading device for reading identification features that are located in an identification tag or an object adapted to be identified, wherein the identification tag or object comprises an engagement track formed as a protrusion in the tag or the object, wherein said engagement track is used to read the identification features,

said reading device comprising an engagement element having a recess that is essentially complementary in shape to the engagement track of the identification tag or object, wherein the engagement element comprises in a lateral region of the recess a reading element adapted for reading the identification features located in the identification tag.

In addition, the invention also encompasses an identification system for identifying an object of interest. This system comprises an identification tag or object as described here and a reading device as also described here. The identification system may further comprise a data storage medium in which a “pre-stored reference signature” obtained from a reference reading of the identification tag or object is stored.

The identification features used in the present invention can be any known features that are presently used in security technology as a means to later identify or verify the authenticity of an object of interest. The identification features may for example, be the information stored/located in chip such as a radio frequency tag identification (RFID) chip or a contact-based chip. The information features can also be located in a serial number or a magnetic strip or (arranged as) a conventional barcode, either a one dimensional or two dimensional barcode or as any other optical marking such as a hologram or a logo. The identification features can also be formed by a randomly distributed material, for example a material containing randomly distributed particles. The randomly distributed particles may comprise a plurality of randomly distributed magnetic or magnetizable particles, a plurality of randomly distributed conductive and/or semiconductive particles, a plurality of randomly distributed optically readable or optically active particles or a mixture of said particles. Examples of suitable randomly materials or particles include, but are not limited to, the porous materials filled with magnetic or electrically conducting material described in US patent application 2005017082A1 or the international patent application WO 2005/008284, or the particles described in pending PCT application PCT/SG2005/00012, the entire contents of which is incorporated herein by reference. Other examples of randomly distributed materials that can form the identification features include fibres randomly dispersed fibres in a sheet of paper or bubbles as described in US patent application 20030014647, for example. Other examples include continuous light pipes with two ends arranged on one or more edges of a layer such as described in PCT application WO 87/00604 or the U.S. Pat. No. 4,682,794.

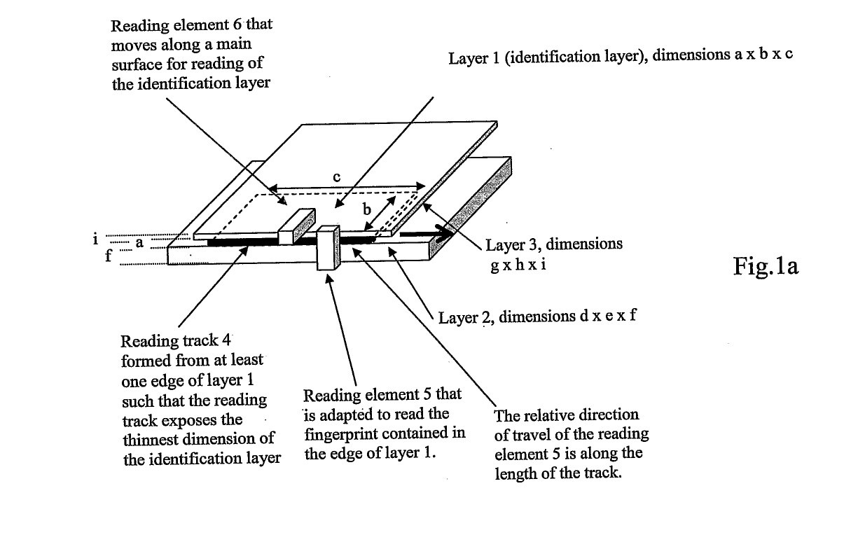

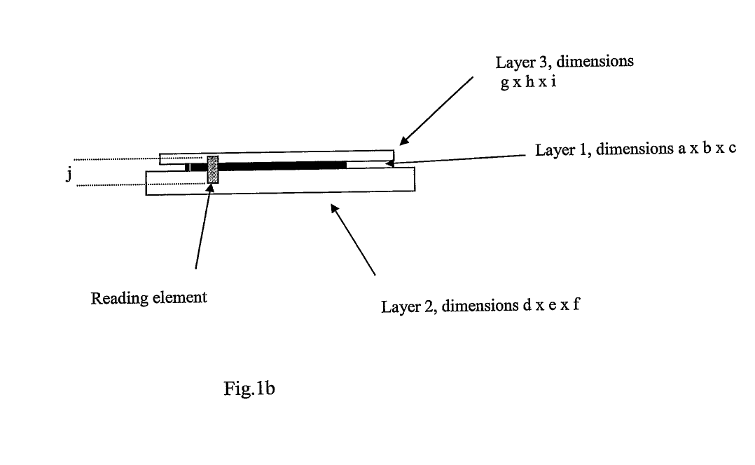

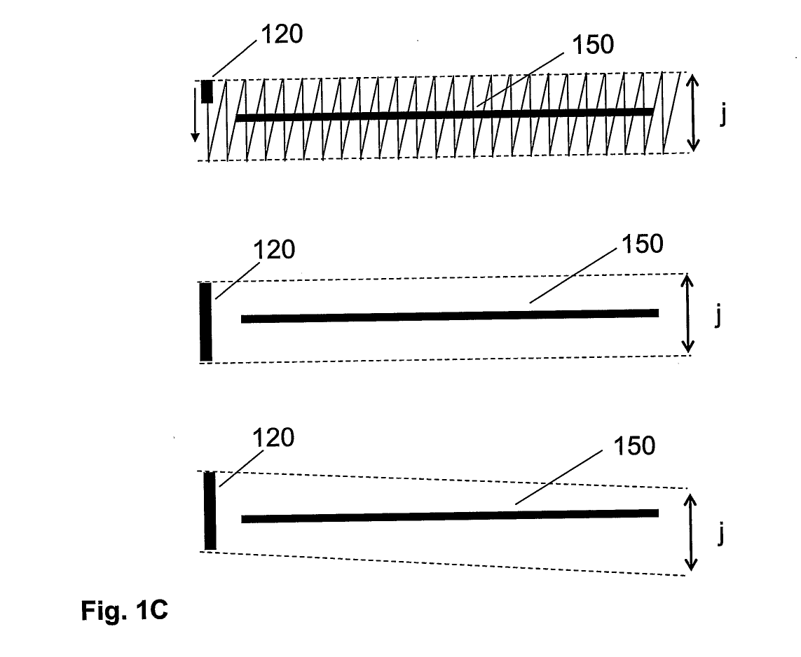

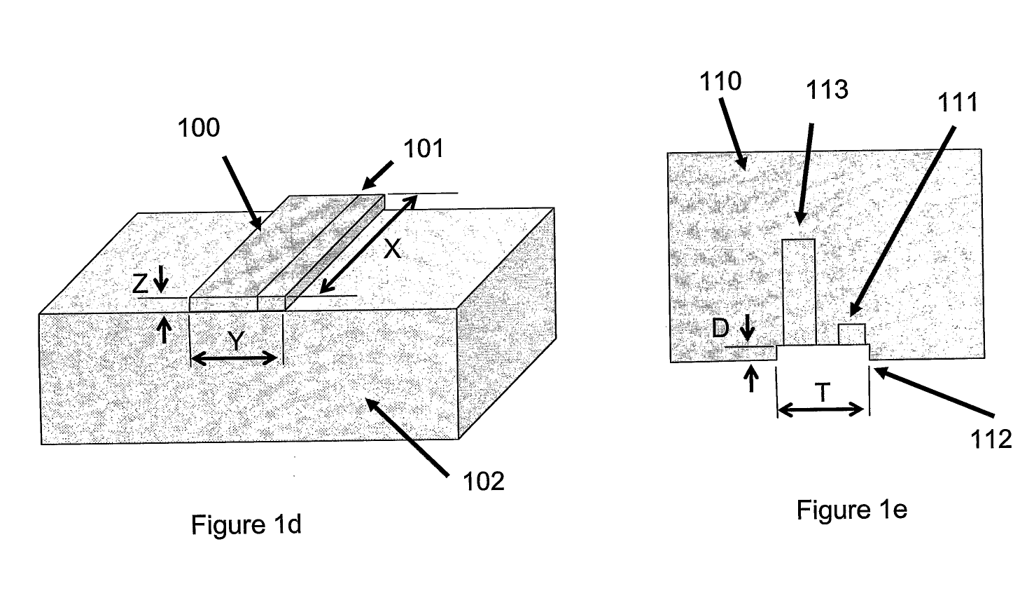

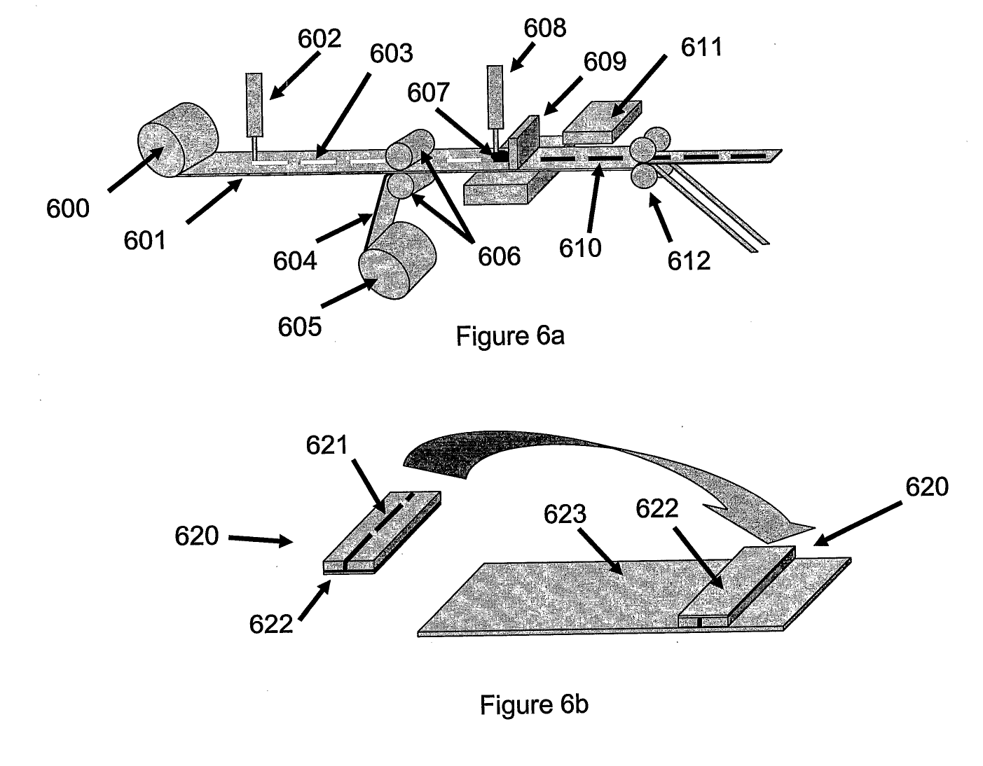

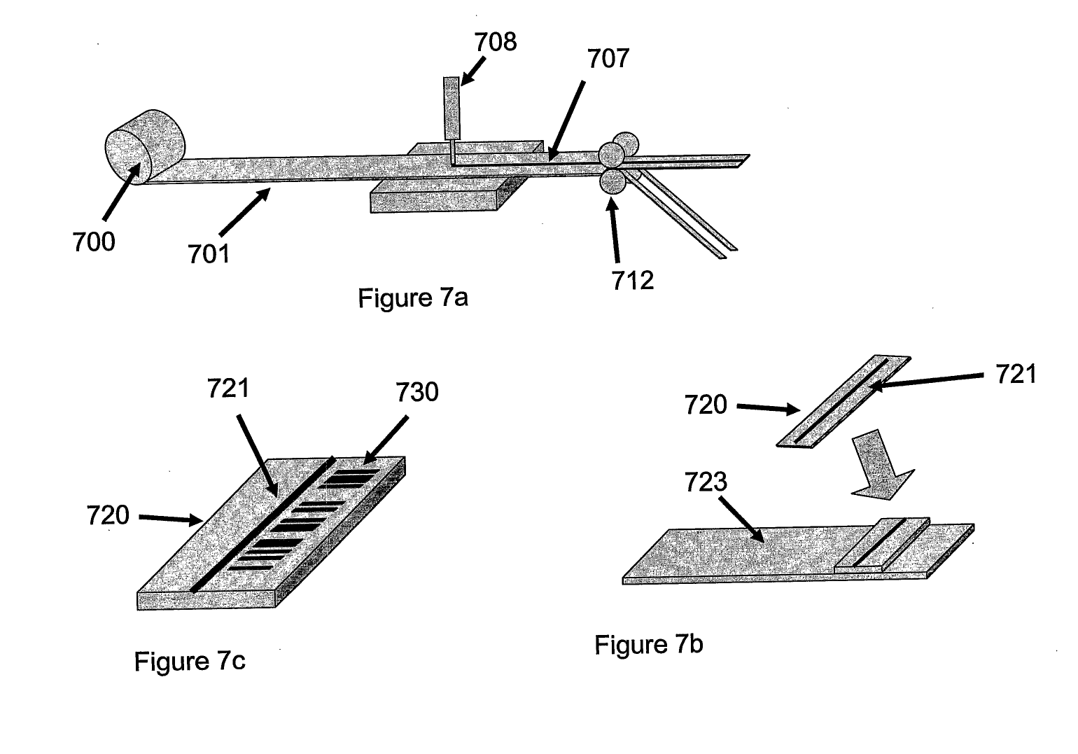

In case of using identification features such as a barcode or randomly distributed particles, the identification features can be arranged in a layer or layer-like structure (considering that a one dimensional barcode is printed on a surface, thereby resembling a layer). In other embodiments (see for example, FIG. 6 and FIG. 7), the identification features are arranged in a more strand- or hair-like configuration. In this context, the terminology used herein will be clarified in the following with reference to FIG. 1A and FIG. 1B. The discussion below describes the embodiment where the identification layer comprises randomly distributed material such as particles. As shown in FIG. 1A a tag or an object of the invention may comprise a layer structure with one or more layers, for example two or three.
Layer 1 is the identification layer in which readable identification features are located, wherein this identification layer has dimensions a×b×c. This identification layer 1 typically comprises at least in one part thereof a plurality of randomly distributed particles that form the readable identification features. Typically, the thickness ‘a’ of the identification layer 1 is less than either ‘b’ or ‘c’, preferably much less. There is no need that the identification layer 1 be rectangular; in which case b and c are the largest dimensions of the extent of the in-plane shape. In this respect, it is noted that by “layer” a structure is meant that is substantially long or elongated in two dimensions and thin in the remaining third dimension.
As explained also below, the identification layer 1 may be self-supporting—e.g. particles dispersed in a sheet of polymer or in an “accommodating layer” tag as shown in FIG. 6), and therefore layers 2 and/or 3 may not be present in embodiments of the invention that makes use of randomly distributed materials.
The identification layer 1 may be discontinuous—i.e. individually scattered particles, where the particles mainly all lie in a plane, in which case at least layer 2 or layer 3 can be present to support and to adhere.
Layers 2 and 3, if they exist, may be of different dimensions to layer 1, and to each other. There is no requirement for a<f nor for a<i, although this may be preferential in some embodiments of the tag or the object of the invention.
For reading the identification features a reading element (reference sign 6 in FIG. 1A) can read a “main surface” of the layer structure by moving along such a main surface. A “main surface” is defined here as being one of the larger or more prominent surfaces of the identification layer. For example, in FIG. 1A the surface lying in the b-c plane is a “main surface” whereas the surface in the a-c plane is a narrow edge and does not constitute a “main surface” under the definition used herein. Alternatively, as also shown in FIG. 1A, a surface with a usually much smaller surface area than a “main surface” area of the object to be identified or the identification tag can also be used for reading the identification features. If a surface with such a smaller surface area is used for reading the identification features, the thinnest dimension of the identification layer will typically be used. For exposing the readable identification layer a reading track 4 may thus be formed from one or more of the edges of layer 1 such that the track exposes the thinnest dimension (dimension “a” in FIG. 1A) of the identification layer. At least some of the identification features are only meaningfully readable from this track. “Meaningfully readable” as used herein means that on reading (either from a main surface or from the reading track) a unique signal is obtained that is used for identification purposes.
On reading either on a main surface or the reading track 4, one obtains a unique signal such as a magnetic/electrical/optical signal termed the ‘fingerprint’ herein. This fingerprint can be read and stored (with any suitable processing method such as encoding, digital processing, encryption, compression, filtering if necessary, to name only a few) as a ‘signature’. This fingerprint is of course also obtained if the identification features are not formed by randomly distributed material, but is instead a unique identifier encoded in a RFID chip or formed by a unique barcode for example.
The fingerprint may be obtained from reading, using a reading element, a part of or the entire identification features. The reading element can be moved along the object or tag, preferably parallel or “substantially parallel” (as defined below) to a surface exposing the identification features, wherein the interaction of the engagement means (the engagement track and the engagement element) ensures that the relative orientation of the reading element with respect to the readable identification features (contained for example, in the readable identification layer) is maintained in proper correlation so that the identification features can be read out accurately and precisely.
If an exposed surface (i.e. either a main surface or a track, for example) is used, the fingerprint may be obtained from-reading either part of the surface or the entire surface. In this context it is noted that when only the track that is typically formed from at least one of the edges is used for sampling the identification layer, material of the identification layer which is buried within in the identification layer (that can be part of a layer structure) can also contribute to a fingerprint and its signature which is read out and which provides the identification information for verifying the identity of an object or a tag. Therefore, exposing only the thinnest dimension of an identification layer makes it even more difficult to forge the object or the tag of the invention.
Reading the identification features is performed with any suitable reading element. The dimension (height=j in FIG. 1B) of the reading element (or composite element) (the “reading element” is/are sensor/s that detects the fingerprint along a main surface or a track) may be equal (or greater) than the surface track width, so that it senses all the fingerprint information across the track. If the reading element is narrower than the surface width (either width of a main surface or a track) then the reading element can also be moved so that it scans an area whose width is greater to or equal than the surface width. Exemplary methods of scanning the area are shown in FIG. 1C—in this case the scan width is now defined as “j”. In FIG. 1C the reading element 120 is shown scanning a track 150 containing identification features. Furthermore if the reading device is based on a remote reading technique such as magneto-optical reading, then the “reading element” as described above and the associated dimension “j” should be understood to mean the width of the area scanned by, for example, the optical beam as a opposed to being the dimensions of a physical element. FIG. 1C shows a scan that is “substantially parallel” i.e. where the scan is not exactly parallel to the track, however it is near enough to parallel that the reading element straddles the track throughout the reading of the fingerprint. Consequently the term “substantially parallel” is a relative term since it depends on the width of the reading element being used, the width of the track and also the length of the fingerprint reading.
With reference to FIG. 1A, it is noted that layer 1 may be included as part of the object itself (further layers such as layers 2 and/or 3 may also be present as part of the object). Alternatively, in a tag of the invention the layers 1, 2 and 3 are the object themselves (a tag) that can be attached to another object.

As illustrated in detail in the following description and the attached figures, the engagement track and the engagement element used in the present invention may adopt any possible shape as long as their shape is essentially complimentary to each other such that, upon engagement of the engagement track and the engagement element, the relative orientation of the reading element with respect to the readable identification features is maintained in proper correlation so that the identification features can be read out accurately and precisely. Both the engagement track and engagement element can thus be of any complimentary regular or irregular shape. The engagement track can, for example, be designed as a recess (for example a groove, or a slot) as a protrusion, as a cavity or as other structure that is capable of physically/mechanically engaging with an engagement element. A recess such as a slot or groove can for example have a polygonal shape (seen in cross-section) such as a triangular shape, a quadrangular shape, a rectangular shape, a trapezoidal shape, a pentagonal shape, a hexagonal shape, or an octagonal shape. Likewise, a protrusion, when seen in cross-section can also have such a polygonal shape, meaning triangular shape, a rectangular shape, a trapezoidal shape, a hexagonal shape, or an octagonal shape. If the engagement track is formed as a cavity in the object or tag, it can of course also adopt any regular or irregular shape complementary to the shape of the engagement element. The engagement track may have an essentially circular or polygonal shape, when seen as a top view of the cavity, for example a cavity with a circular, semicircular, or an elliptical cross-section. Alternatively, seen in top view, a cavity-shaped engagement track can be of polygonal shape such as a triangular shape, a rectangular shape, a trapezoidal shape, a pentagonal shape, a hexagonal shape, or an octagonal shape.

In typical embodiments of the invention, the engagement track of an object or tag of the invention has an extension (a depth, when formed as a recess or a height, when formed as a protrusion) of at least about 50 micrometers, of at least about 150 micrometers, of at least about 200 micrometers, of at least about 250 micrometers, or of at least about 500 micrometers up to the millimetre (for example, 1 or 2 millimeters) and centimeter range. Accordingly, the engagement element of the reading device has the same corresponding height or depth or also a greater height or depth in order to avoid that other parts of the reader contact a surface area of the tag or object thereby hampering the reading process. If formed as a cavity, the engagement track may have a depth of at least 50 micrometers, but more preferably a depth of hundreds of micrometers or more including millimetres or centimetres, for example, but not limited to, about 1 to about 10 cm.

In this context it is noted that in the invention as described here an identification tag and an object adapted to be identified both comprise by themselves identification features that can be read in order to obtain a signature that allows authentication. Accordingly, in some embodiments an identification tag and an object to be identified can in principle have the same physical structure. In addition to an object that is adapted to be identified the invention is also directed to objects that are rendered identifiable by attaching on or incorporating therein an identification tag as described here. In principle, any object of interest can either be tagged/equipped with an identification tag described here or can be rendered into an object adapted to be identified.

In the context it is also noted that the terms “individually tagging”, and “identifying” and their derivatives are used interchangeably to particularly mean marking an item in such a way that it can be distinguished uniquely from other items. Although terms such as “watermarking” may be sometimes used in this context, these terms generally refer to distinguishing a group of items from another group of items, e.g. a banknote watermark distinguishes it from a fake note, but it does not distinguish a banknote from other individual genuine banknotes. The terms “counterfeit”, “fake”, “forge” and “copy” are used interchangeably.

Illustrative examples of objects that can be tagged according to the invention include engineering components such as metal components which are difficult to tag or mark securely against counterfeiting. Metal components are difficult to tag using RFID, for example, because the metal interferes with the signals from the RFID tags. Therefore, in such embodiments, the identification features are typically (but not exclusively) formed by identification features the reading of which does not interfere with metal. Examples of such identification features are magnetic (for certain forms of metal), semiconductive, optically active or optically distinguishable particles. Examples of engineering components include automotive components such as brake discs, oil filters, drive train components such as drive shafts, engine blocks, chasses, air condition housings, suspension components such as struts and shock absorbers to name only a few. Other engineering components may be components for aviation, power generation, construction, infrastructural (e.g. water management) military or recreational purposes. The engineering components can be made out of any typical material used such as metal, metal alloys, ceramics, polymeric materials, carbon fibres or composite materials. Other objects that can be tagged or into which an identification layer can be integrated in accordance with the invention are electronic components such as lead frames, packaging material (for example for pharmaceutical products, electronic devices, tobacco products, and agricultural products). Other examples of goods are credit cards, certificates, bank notes, security access cards, vehicular key-cards, passports, identity cards, media disks (e.g. CDs, DVDs) or luxury items such as handbags, leather goods, spectacles frames.

In the following, some presently preferred embodiments of the identification tag and the object of the invention are described. These embodiments are also applicable to the reading device, the identification arrangement, the identification system, the method for forming an identification tag and the method for reading identification information.

In some embodiments, the tag or the object of the invention may comprise a supporting layer on which the identification layer is arranged.

In an embodiment of a tag comprising an accommodating layer, this accommodating layer comprises at least one accommodating recess (see FIG. 6). The accommodating recess in turn comprises the at least in part randomly distributed material that forms readable identification features for identifying the object. The accommodating recess can be arranged essentially in longitudinal direction of the accommodating layer, or alternatively, arranged essentially in cross sectional direction of the accommodating layer or alternatively it may be arranged in other orientations, for example in a 30 to 40 degree angle relative to the longitudinal direction. The accommodating recess can either be continuous or perforated. The term “accommodating recess” as used herein includes any kind of portion that is arranged within the accommodating layer and that is adapted to contain randomly distributed material. The accommodating recess can be a cut or a cutting mark, a hole, a groove, a trench, a recessed area or a through hole arranged in the accommodating layer. The accommodating recess may be covered in the final form of the object or tag. The term “randomly distributed material” as used herein refers to a material that has been distributed randomly on a surface, or within a plane or within an accommodating recess as such as well as to a material or composite that comprises randomly distributed features such as particles or fibres. The word “particles” when referring to randomly distributed particles is meant to also refer to features that can be used for identification purpose such as physical particles, voids, bubbles, domains (e.g. materials containing magnetic domains) and variations within a continuous material, for example roughness and colour variations. The use of bubbles as identification features is described in US patent application 20030014647, for example.

The randomly distributed material can be included into a part of the entire accommodating recess, for example, by using a curable (precursor) liquid polymer composition in which particles are randomly dispersed or emulgated. This liquid composition can be brought into contact with the recess, for example, by printing, squeegeeing or spraying the mixture of the liquid composition with the material dispersed therein onto or into the recess. After solidification of the precursor, for example by curing the polymer precursor by means or infra-red (IR) or ultraviolet (UV) light such compositions yield a mechanically stable and chemically inert matrix that ensures that the identification features are safely embedded therein. In addition, the composition once it is solidified can also assist that the accommodating layer is self-supporting and thus, if desired, that the accommodating layer can be used without the need of a further layer that supports the accommodating layer. In this context it is also noted that the composite material (formed by the (cured) matrix material and the particles that form the identification features) is usually uniformly distributed within at least a part or the entire accommodating recess whereas the particles forming the identification features are randomly distributed (embedded) in the matrix material.

Examples of suitable compositions include polymeric adhesives or inks. Illustrative examples of constituents of suitable adhesives or inks include conventional (dielectric) organic polymers/resins which are IR- and/or UV-curable curable such as polystyrenes, epoxy resins, polyalkylenes, polyimides, polybenzoxazoles, polyacrylates, polyether, polybenzoxayoles, polythioayoles, epoxides, (meth)acrylates, or polysiloxanes that are also described in US patent application 20040082098, for example. Other suitable compositions include those that are described in US patent applications 20050245633 and 20050245634. It is also possible that the printable composition that contains the randomly distributed particles may consist (exclusively) of a meltable matrix material and particles that form the identification features dispersed therein. Examples of suitable meltable matrix materials of this type are thermoplastics, such as polystyrene, or inorganic matrix materials, such as metals (particularly low melting point metals and metal alloys such as solders), green ceramics, which are distinguished by their low melting point. Thus, a mixture of such a composition and particles that form the identification features can deposited in the accommodating recess in solid form and converted into a composite material by heating about the melting point of the meltable matrix material and letting the melt solidify thereafter. A printable composition may also be based on an aqueous liquid, an organic liquid, a mixture of at least two organic liquids or an organic-aqueous liquid mixture. This liquid can act as a solvent, with the result that the precursor of the matrix material as well as the particles that form the identification features may be either dispersed or dissolved in the composition. Inorganic matrix materials such as ceramics are typically present in an ink in form of a dispersion; however, they may also be dissolved in an aqueous or organic solution. One example of a dissolved inorganic matrix material is sodium (ortho)silicate, which is solidified by the addition of acid and can then be sintered in a conditioning step to discharge water.

It is also possible to use a material for forming the identification features in the accommodating recess that does not need to be embedded into a matrix. Such a material can be any material that after deposition into the recess is able to remain at the same position in the recess permanently (or at least over the time period for which the identification tag is to be used). Examples of suitable materials include adhesive particles or fibres such as for example fluorescent, magnetic or radioactive latex or latex coated beads. Such beads can for example be dispersed into a liquid, printed into the accommodating recess and then immobilized therein by heat treatment which at the same time can also evaporate the liquid used for printing of the particles. Alternatively, the material may itself contain identification features, for example a continuous material that contains domains (e.g. magnetic domains or domains of varying reflectivity etc).

The identification tag comprising the accommodating layer is, like the other tags described here, adapted such that it is attachable to an object to be identified. For this purpose at least one surface of the accommodating layer is least partly adhesive or at least partly suitable to be subjected to thermal bonding. As the accommodating layer can be self-supporting (see above) such a tag can used without any further support layer. However, it is also possible to arrange the accommodating layer on a support layer, if wanted. If a support layer is used, the surface of the support layer that is opposite the surface that contacts the accommodating layer may be at least partly adhesive or at least partly suitable to be subjected to thermal bonding. Accordingly, the accommodating layer or the support layer (if the latter is present) may comprise or consist of any material that can be thermally bonded or for example glued on an object without affecting the integrity of the tag, in particular the accommodating layer that comprises the identification features. Suitable materials include polymeric materials (both organic and inorganic polymers), metals, ceramics and natural organic materials such as leather and processed natural organic materials such as cotton textiles. Illustrative examples of polymeric materials are selected from the group consisting of polystyrene, polyethylene, polypropylene, polyethylene terephthalate, polyether, polycarbonate, polyethersulfone, epoxy resins, polystyrenes, polyurethanes, polyacrylates, polyimide, polysilicones, to name only a few.

The afore-mentioned tag as well as any other tag or object of the invention may comprise a cover layer. In case, the randomly distributed material is not embedded into a matrix that is self-supporting, either the cover layer or a support layer can be used in order to support the randomly distributed material in the recess, for example, by immobilizing the randomly distributed material in an area of the support or cover layer that is in contact with the accommodating recess. If a support layer is present the identification layer may be arranged between the support and a cover (top) layer. In principle, every material that is compatible with the identification layer can be used both as support and/or cover layer. Examples of suitable materials include again, but are not limited to plastics, metals, ceramics, textiles, natural organic materials such as leather or wood, glass and combinations thereof. Examples of suitable plastics include polymeric materials such as polyethylene, polypropylene, polyester, polyether, polystyrene, polycarbonate, poly(meth)acrylate that are commonly used for the production of plastic articles such as bags, credits cards, packing materials, sheets etc. Suitable glasses and ceramics include, but are not limited to, alumina, silica, bone china, enamels, and vitreous frits.

By the use of a cover layer or a support layer (in case of a two layer structure) or the sandwich structure (in case of a three layer structure), the identification layer can be (further) structurally supported and may also be electromagnetically shielded from below and from the top (in the case of the sandwich structure). Such a layer structure further allows the exposure of the thinnest dimension (from an edge) of the identification layer, if this is wanted. The thinnest dimension of the identification layer can be easily exposed (and so the track obtained from one or more of the edges of the identification layer) by simply cutting, polishing or abrading the identification layer (or a layer structure if a support and/or covering layer is used) at an angle greater than 10 degrees to the plane (or in some embodiments substantially perpendicular to the plane) of the identification layer or the layer structure.

The layer structure of the identification tag may comprise at least one further identification layer arranged between said bottom layer and said top layer.

By providing one or more additional identification layers, the identification features can be divided in a plurality of identification layers, thus further increasing the security, since the effort needed to imitate the information included in the identification layers is thus significantly increased. Moreover, this measure can introduce redundancy in the system further increasing the reliability of the identification tag.

The layer structure may comprise at least one intermediate layer arranged between said identification layer and said further identification layer.

If the thinnest dimension of the identification layer is used for reading, the different identification layers may, by taking this measure, be separated spatially from one another. This allows separate and/or simultaneous reading of the information located in said identification layer(s). Thus, a further redundancy may be included which also improves the reliability of the identification tag or object of the invention.

The tag or the object of the invention may also comprise an alignment marking that further facilitates the alignment of the reading part of the reader during the process of reading said identification features.

The identification layer(s) may comprise, at least in parts of the layer(s), a plurality of randomly distributed particles. In some embodiments, the identification layer comprises, as described in US patent application 2005017082A1 or the international patent application WO 2005/008284, a host material having pores, wherein at least some of the pores contain the particles. The particles may consist of a magnetic or magnetizable material or of a substantially electrically conducting material. In other embodiments, the particles may be randomly dispersed in a matrix or the particles may be provided by sputtering/ion implantation

By providing such a (highly) disordered structure with particles to define the identification features in the identification layer, the information can only be imitated with extremely high effort and/or cost thereby improving the security of the identification system.

The identification layer may comprise a plurality of magnetic (or magnetizable) particles. By implementing magnetic (or magnetizable) particles as randomly distributed and/or oriented particles, a magnetic read head can be used as a reading element that moves along the track that exposes the identification layer, thus reading a fingerprint of the identification features that is formed from the magnetic field distribution caused by the magnetic (or magnetizable) particles, thus providing an inexpensive and highly reliable identification structure. Any material exhibiting magnetic properties can be used in the identification layer, including but not limited to magnetic materials such as ferrimagnetic materials, antiferromagnetic materials and ferromagnetic materials. Magnetic materials used include but are not limited to ferromagnetic materials such as Fe, Ni, Co, Gd, Dy, the corresponding alloys, oxides and mixtures thereof, and other compounds such as MnBi, CrTe, EuO, CrO₂ and MnAs. Other materials influenced by magnetism are also contemplated. Examples of such materials include ferrimagnetic materials e.g. spinels, garnets and ferrites such as magnetite. Other materials commonly used in magnetic media, such as alloys of Ce, Cr, Pt, B, Nd (e.g. Nd—Fe—B, Nd—Fe—Co—B, Nd—Pr—Fe—Co—Ti—Zr—B), Sm (e.g. SmCo₅), and alloys such as, AlNiCo, Permalloy and MuMetal are also contemplated. The identification information may also be formed by domains of varying magnetic properties within a continuous material including voids in the material that cause variable magnetic properties. Such domains of varying magnetic properties are thus encompassed in the term “magnetic or magnetizable particles”.

In case a porous material is used the pores of which are at least partially filled, the host material is a substantially non-magnetic material. In general, any porous host material that is at least substantially non-magnetic (magnetically inert) or substantially electrically insulating can be used in the present invention. Usually, this host material has good mechanical, thermal and chemical stability in order that migration of the material in the pores to other regions of the host material is prevented or negligible. In addition, the host material's stability minimizes oxidation and unwanted chemical modification of the material in the pores. Such properties enable the magnetic, electric or electromagnetic signal obtained from the tag to remain uniquely identifiable. A suitable host material can, for example, comprise porous alumite prepared by the anodization of aluminium films as described in U.S. Pat. Nos. 5,139,884, 5,035,960 or Nielsch et al., Journal of Magnetism and Magnetic Materials 249 (2002) 234-240. Thus, the host material of the tag can be alumina.

Other suitable host materials include porous polymeric films (usually bi- or tri-block copolymers where one component has been selectively removed) or porous semi-conducting materials such as porous silicon or porous III-V materials (see, for example, Föll et al., Advanced Materials, 15, 183-198 (2003)). Examples of III-V materials suitable for use as a porous host material in the present invention include GaAs, InP and AlAs. Another suitable host material is zeolites. Examples of suitable zeolites include any one of the members of the zeolite mineral group, for instance clinoptilolite, chabazite, phillipsite and mordenite. Other suitable porous materials include inorganic oxides such silicon oxide, zinc oxide and tin oxide.

Additionally or alternatively, the identification tag or object of the invention may comprise a plurality of conductive or semi-conductive particles. Also in the case of conductive or semi-conductive particles, the identification information may also be formed by domains of varying conductive properties within a continuous material including voids in the material that cause variable conductive properties. Such domains of varying magnetic properties are thus encompassed in the term “conductive or semi-conductive particles”. Electrically conducting materials include metals, such as but not limited to Cu, Sn, Fe, Ni or alloys thereof. Examples of semi-conducting materials include (poly)silicon, gallium arsenide, gallium nitride, platinum silicide, silicon nitride or sichrome (SiCr), to name only a few. According to this embodiment, a magnetic read head can be used as a reading element for sampling the identification layer to read the identification features that are formed from an electromagnetic field distribution caused by passing current through at least some of said particles. Similarly, an electrical parameter like the resistivity, conductivity, impedance, or the like of the randomly distributed conductive or semiconductive particles as a function of position within the identification layer may be detected using a suitable reading device (such as a conductive sensor). In the case of a porous host material the pores of which can be filled with electrically conducting particles, the same host materials given above in connection with the magnetic particles may be used.

In addition or alternatively, the identification tag or object may comprise an identification layer comprising a plurality of optically reflective, absorptive or active particles. By ‘optically active’ it is meant in the present application particles that change the wavelength and/or plane of polarization of light that is transmitted through or reflected from them. According to this embodiment, an optical detector can be used as a reading element for sampling the track formed from the identification layer to read the identification features. These identification features may be formed from, for instance, particles that fluoresce at a specific wavelength, chiral particles that change the plane of polarization, or a mixture of particles that fluoresce at different wavelengths and/or change the plane of polarization of interacted light, to name only a few possibilities. It is also possible to use optically distinguishable particles as identification features. Examples of optically distinguishable particles include metal particles, ceramic particles, polymeric particles, naturally occurring particles such as the fibres within paper, or voids or bubbles and domains of varying optical properties within a continuous material and mixtures and combination thereof.

The invention may also include a combination of magnetic and/or magnetizable and/or conductive and/or semi-conductive and/or optically active particles and/or optically distinguishable particles to further improve the reliability and the security of the system. In one case, for instance, a combination of an optical verification and a magnetic verification can be implemented. Typically, the average particle that has a significant effect on the fingerprint including voids and domains present in the identification layer may have a largest dimension (but not limited to) of between about 10 nanometers to about 500 micrometers.

In the identification tag or object of the invention, a plurality of identification layers each comprising identification features is contemplated, wherein each identification layer is readable independently from other identification layers.

By reading individual layers, different kinds of information can be located in the identification tag or the object of the invention (e.g. identification features and additional information like a price of a product to which the tag may be attached or background information concerning such a product).

In a further embodiment the surface(s) that expose(s) the identification layer(s) is/are covered by a protective coating. In principle, every material that is suitable for physically protecting the identification layer from environmental damage (for example, by chemical and/or mechanical degradation) can be used, as long as this material does not prevent that at least some of the identification features are meaningful readable from the track. Examples of suitable material that can be comprised in the protective coating include, but are not limited to, polymeric coatings such as Teflon coating, a rigid polymer, a sol gel or vapour deposited material such as an oxide, nitride, amorphous diamond, a diamond-like material (film) such as diamond-like carbon, tetrahedral amorphous carbon or a spun-coated lacquer. This protective coating (layer) may be a “hard” material. A “hard” material is defined herein as a material preferably having a bulk yield stress of 50 mega-newtons per square metre, i.e. 50 MN/m², or more. An example of a suitable polymer that acts as the hard material is poly methyl methacrylate which has the advantages of being tough and transparent. A single coating layer of poly methyl methacrylate can be produced by dip or spin coating the tag with a solution of monomeric methyl methacrylate. The monomer solution is polymerized during or after coating.

In the following, preferred embodiments of the reading device of the invention will be described. These embodiments are also applicable to the identification tag, the object adapted to be identified, the identification system, the method for forming an identification tag and the method for reading identification information.

The reading element may be adapted for reading information from a plurality of randomly disordered particles included in the identification layer.

Thus, the reading element may be adapted to detect a signal resulting from the characteristic arrangement of the randomly oriented particles providing a unique fingerprint (and signature).

The reading element may be adapted for reading information from a plurality of magnetic or magnetizable particles included in the identification layer. In this case, the reading element is a magnetic reading element.

The reading element may also be adapted for reading information from a plurality of conductive and/or semiconductive particles included in the identification layer. According to this embodiment, the reading element is an electrical or electromagnetic or magnetic reading element reading out an electrical parameter characteristic for an arrangement of randomly disordered particles.

The reading element may further be adapted for reading information from a plurality of optically active or optically distinguishable particles included in the identification structure. According to this embodiment, the reading element is an optical reader or detector which may read out an optical parameter such as a reflectance or fluorescence intensity, an optical anisotropy, or the like. The reading element can also be adapted to detect photons reflected from or deflected by a plurality of randomly distributed optically distinguishable particles included in an identification layer of the tag or the object

It is also possible to use a reading element having at least two different types of reading capabilities, for example, magnetically and optically, or electrically and magnetically. So doing, the security can be further improved.

The reading device can further comprise a tracking element. This tracking element is adapted to further facilitate or measure alignment or motion of the reading element relative to the identification features being read during the process of reading the identification features.

For so doing, the tracking element can be adapted for optically positioning the reading element with respect to the identification features. The tracking element can also be adapted for optically measuring the relative position of the reading element with respect to the identification features being read. According to these embodiments, a visual mark can be provided as a positional reference mark or as an alignment mark on the object or identification tag indicating a path along which the reading element should be guided in order to further facilitate an error-free detection of the identification features located in the identification layer. As an example, an optical sensor and a feedback loop linked to the actuation mechanism of the reading element can achieve this.

The reading device may further be provided such that the tracking element is adapted for electromagnetically guiding the reading element along the surface used for reading the identification features. The tracking element can also be adapted for electromagnetically measuring the relative position of the reading element with respect to the identification features being read. According to these embodiments, a readable electromagnetic guiding layer or feature is provided as a positional reference mark or an as alignment mark. This may, for example, be a structure of ferromagnetic material, which allows an auxiliary sensing element of the tracking element to follow a path along which a fingerprint shall be captured.

According to a further embodiment, the reading device may have a processing means adapted to compare the signature of the fingerprint read by the reading element with a pre-stored reference signature, and to identify an identification tag to be valid, if the signature read from the identification tag differs from the pre-stored reference signature by less than a threshold.

In other words, a pre-stored reference signature can be stored in a data storage medium of a reading device (or of a remotely located storage medium which can be accessed in order to validate the read signature—an example of this would be a database connected to the internet so as to allow signatures read by remote devices to be verified) as a set of parameters. This set of parameters may be compared with a signature detected in a particular case, wherein this measured signature is compared to the pre-stored reference signature stored in the data storage medium. If the deviation between the measured and the pre-stored reference signature is less than a threshold value, the identification is considered to be verified. In turn the object as such or the object to which the tag is attached may be considered authentic. It is however not necessary that the pre-stored reference signature is stored permanently in the memory of a reading device. Rather, the reading device can be designed such that it is able to receive the pre-stored reference signature that is stored in a data storage medium remote with respect to the reading device. Alternatively, the reading device may be able to receive the pre-stored reference signature that is stored in the object to which the tag is attached or the object to be identified. In this context, it is noted that the object or the tag of the invention may additionally have stored further information, for example, the price of the object, the manufacturer thereof or the like. Such information may be included in a conventional bar code, a two-dimensional bar code, a magnetic strip or a memory chip. The reading device may thus also be adapted to read such a signature from a conventional barcode, a two-dimensional barcode, a magnetic strip or memory chip. Another alternative is that the reading device is adapted to send the read signal (possibly via a communication device such as a computer attached the to internet or via a mobile communication device such as a cellular phone) to a remotely located device (such as a server computer) where the database of pre-stored reference signatures is housed, and said remotely located device is able to compare the read signature with the relevant pre-stored reference signature(s). Upon matching the read signature with a pre-stored reference signature the remotely located device can send a message back to the reading device (or to the communication device) to verify the item and provide the user with any other pertinent information store on the database. Of course if no match is found the remotely located device can return a signal stating that no match was found and other information (such as suggestions on what steps the user should take in these circumstances).

The processing means may further be adapted to update the pre-stored reference signature by re-writing or appending the pre-stored reference signature using information from the most recently read fingerprint/signature and storing the signature from the read fingerprint as an updated reference signature for a future verification check. When using the identification tag or the object adapted to be identified for a longer period, abrasion of the track or the entire identification layer may occur as a consequence of the intense use of the identification tag. Such an abrasion may cause the characteristic signature to be changed. In a static system, in which the pre-stored reference signature would always stay constant, such an abrasion effect may have the consequence that an identification tag is not recognized by the system. Thus, the dynamic system that is used in one embodiment of the invention updates changes in the detected signature and stores this updated signature as the pre-stored reference signature. Thus, small changes with time due to abrasion of material of the identification layer can be taken into account, thus improving the functionality of the system, since an erroneous classification of a tag or the object to be non-valid as a consequence of abrasion is avoided.

In accordance with the above disclosure, a conventional read head can be used in order to determine a characteristic (signature) that represents the identification features of the tag or the object adapted to be identified. Examples of read heads that can be used are those used in cassette tape players, video cassette recorders (VCRs), magnetic data storage tapes, hard disk drives, Zip™ discs, Jaz™ disks and magnetic stripe readers, for example. Alternatively, a magnetic force microscope, commonly known as an MFM, can be used. In addition, detection of magneto-optical effects such as the magnetic Kerr effect can be utilized. For determining characteristics such as the electric or electromagnetic field strength, any conventional high sensitivity electric field meter or EMF gaussmeter which can be calibrated to a suitable frequency can be used for this purpose. For determining optical characteristics, any photodetector or photodiode may be used equipped where necessary with polarizing filters and/or colour filters for example.

Once the signature from the object or the tag has been determined, it can be subjected to mathematical procedures to process (e.g. filter, smooth, take Fourier transforms or other mathematical signal processing techniques) and/or compress and/or encrypt the signature prior to storage. The first measured signature (or if desired a subsequent measured signature), either in the form of the raw signal obtained from the reading of the tag, or in its processed/compressed/encrypted form, can be stored in a variety of data storage media such as a hard disk, smartcard, RAM module, tape storage, magnetic stripe or any other data storage media (so becoming the pre-stored reference signature).

In the invention, the first signature can be obtained from scanning a surface area that encompasses the entire identification features comprised in the tag or the object of interest. It is however also possible to obtain this first signature only from reading a portion of a surface, thereby reading only a portion of the identification features. For example, in applications which require a lower level of authentication it may be sufficient to read only a portion of the surface or track (if the thinnest dimension of the identification layer is exposed. This ‘partial’ signature then becomes the pre-stored signature (identification information). In this way, processing time for reading and recording the signature of new tags or objects can be reduced.

The requirement for only a “partial” signature also makes it more complicated to forge, because the portion used is not required to be identifiable from the identification features comprised in the identification layer of the tag or object alone, but preferentially forms part of an independent instruction within the overall system. This means that, in general, a counterfeiter is forced to reproduce the entire identification layer (meaning the entire tag or object), despite only some of the information being used to authenticate the object. Typically, duplicating the unused portion increases the cost and effort needed to counterfeit the tag without significantly increasing the cost and effort for the original producer or legitimate user.

As can be seen from the above, it is possible and common on a practical level that obtaining the pre-stored reference signature and the signature taken for identification purposes to take place at different times and locations. For example, manufactured tags can be read first where the signatures are obtained and stored on a data storage medium before the tags are delivered to the user of the tag (for example, a supplier of parts for the automotive industry). This tag user then affixes the tag to an object to be tagged, for example, an automotive component before distributing it to its customers. Alternatively, the tag can be read by the tag user only after the tag user has attached the tag onto or included the tag into an object. In case of objects adapted to be identified, the signatures will typically be read where the objects are manufactured and the pre-stored reference signature can, if so desired, be sent to a remote location and stored there. In case of both the use of a tag or an object, the user such as a automotive part supplier or a pharmaceutical manufacturer may store further information/content such as product information and the like on the an object or tag containing an identification layer as described here. Or, in case of a data storage media such as a CD containing such an identification layer of the invention, a user such as record company may store music on the CD and then distribute to its customer. This customer may then obtain the second signature and compare the obtained signature with the pre-stored reference signature (which may be stored in a remote data storage medium)—in order to verify the identity of the object. Alternatively, the tag user may affix the tag to the object prior to reading the tag and thereafter send the signature to the data storage medium (likewise, the object user may first produce the commercial item of interest and send it the to a remote location where the reference signature is read and stored on a data storage medium). In both cases, identification information is obtained in the form of a signature from a tag or an object of interest and is stored on a data storage medium for subsequent identification of the tag or object.

In this context, embodiments of the method for reading identification features in an object or a tag of the invention are discussed in the following.

In one embodiment information is read from a plurality of randomly distributed particles that are included at least in part of said identification layer. The plurality of randomly distributed particles can be magnetic or magnetizable, conductive or semiconductive or optically active or optically distinguishable particles.

In the case where magnetic particles are used the reading may comprise determining at least one characteristic of a magnetic field of at least a portion of the identification layer of the tag or the object. Thereby a specific magnetic signal is obtained. In this case, the identification layer may comprise a substantially non-magnetic host material having pores, wherein at least some of the pores contain a magnetic material.

The reading may be at least one characteristic of the magnetic field of the portion of the identification layer that is highly dependent on the disorder of the identification layer. More specifically, the disorder may be related to at least one of the properties of the identification layer, for example, size, shape and orientation of pores, inter-pore distances, percentage of pore filling and crystal orientation of magnetic material in the identification layer. For example, if a porous host material is used the disorder can be a characteristic of the host material alone. As an example for this, a host material can be used that has different pore sizes and interpore distances, and the pores of this material can be (equally) filled with a magnetic material. It is also possible to use a host with ordered pores in which the disorder is created by varying the filling degree of the material within the pores. It is of course also possible to use an identification layer with a disordered structure and also vary the percentage of filled pores or (in the case of magnetic material) the crystal orientation of the material within the tag, for example. Another alternative is for the porous host material to be magnetic and for the fingerprint to arise from the disorder in the size and location of unfilled pores (or pores filled with a non-magnetic material). The above properties which can be manipulated to produce disorder in the identification layer of the tag or the object can also be considered as degrees of freedom.

In one embodiment the identification layer is subjected to a magnetic field prior to each determination of the at least one characteristic of the magnetic field (the signal) of said portion of the identification layer. In this embodiment, the magnetic material within the identification layer can be remagnetized under the magnetic field before each reading. This increases the magnetic field signal for easy reading. For this purpose, a uniform but also an inhomogeneous magnetic field can be used to re-magnetize the identification layer, such as that produced by simple bar magnets, or the magnetic field generated from solenoids or combinations of magnets.

In one embodiment, the method of further storing (recording) information in the identification layer of the tag or the object is contemplated. This storing (recording) of information can be done by magnetizing the magnetic material that is present, for example, in a group of particles into poled domains, or by determining through patterning groups of particles of the track to contain magnetic (or electrically conducting) material or by a combination of these two approaches. This recording step is preferably done prior to the first determination of the fingerprint or alternatively after this first determination.

Yet another embodiment of the invention includes storing more than one pre-stored reference signature for the object. When the object's signature is read subsequently the read signature can, for example, be compared against all the pre-stored reference signatures for that object or may be compared against all pre-stored reference signatures stored in the database. For example when reading the signatures to be used as the pre-stored reference signatures for the object different reading devices, that means at least two (a plurality) reading devices may be used. The plurality of the reading devices may be configured such that each of them define the spatial relationship between a discrete area of the identification features to be read differently. This difference in the configuration can either be inherently or deliberately introduced. For example, the reading elements of the various reading devices may be purposefully slightly misaligned with respect to each other. This means that the reading's spatial relationship for each reading device would define a slightly different. Consequently the signature from each reading device would be slightly different. By storing all these pre-stored signatures and using them for subsequent verification of the object it makes the verification more robust. For example, consider reading a track of identification features. If the reading element of a first reading device is perfectly aligned, that provides a signature which can be called the “aligned signature”. If the reading element of a second reading device is slightly misaligned (for example, by about 1 micrometer, 10 micrometers, 50 micrometers or 100 micrometers) to the left, that provides a signature which can be called the “left signature”. If the reading element of a third reading device is slightly misaligned (for example, by about 1 micrometer, 10 micrometers, 50 micrometers or 100 micrometers) to the right, that provides a signature which can be called the “right signature”. By storing the aligned signature, left signature and right signature as the pre-stored reference signatures this increase the robustness of the method and system as described below. If many reading devices are being manufactured for commercial sale, there will be certain tolerances and variations between each device. Assuming the maximum misalignment allowable in the manufacturing process is ±50 micrometers, then by storing one or more sets of pre-stored reference signatures corresponding to misaligned readings (including misalignments of at last ±50 micrometers) it means that even the most misaligned production reader still have a corresponding pre-stored reference that would match well with the read signature. A further example of the use of using a plurality of reading devices for deriving more than one pre-stored reference signal is if, the reading elements themselves have some variation in their characteristics (e.g. if magnetic sensors have varying sensitivities). By using a set of reading devices with a range of reading elements the spectrum of signatures possible with the family of reading elements can be recorded. In this embodiment, a subsequently read signature may thus be compared with at least some of with all of the pre-stored signatures that are associated with a particular object or with a family of objects.

In a further embodiment of the invention, in which a barcode or another serialized identification information such as a serial number, binary or hexadecimal information, or an alphanumeric code (e.g. a name) that has been assigned to the object is used as one of the sets of identification information, and if the reading device does not fully, completely or correctly read said barcode or serialized identification information, the processing unit is able to regenerate data or components (e.g. reference points) missing from parts of the read signal based on supplementary information that is keyed in or scanned in separately. For example if the identification information is a barcode and an associated number, the barcode can be scanned with an alternate device and the associated number can be used as the supplementary information to regenerate the data or components (e.g. reference points) missing from parts of the read signal. The regenerated data or component is then used to form a signature for identifying said object.

In a further embodiment, the barcode or the other serialized identification information is used as a primary key with which the pre-stored references signatures are stored and/or retrieved.

The above and other objects, features and advantages of the present invention will become apparent from the following description and the appended claims, taken in conjunction with the accompanying drawings in which like parts or elements are denoted by like reference numbers.

The invention is further illustrated by reference to the following non-limiting examples and drawings, in which:

FIG. 1a shows an identification layer of the invention in combination with an optional covering layer on the top and bottom of the identification layer as present in a tag or an object according to the invention and in combination with a reading element used in the invention.

FIG. 1b a side view of an identification layer of FIG. 1A.

FIG. 1c shows one exemplary method of scanning an area containing identification features.

FIG. 1d shows a tag attached to an object according to one embodiment of the present invention, and FIG. 1e shows a reader adapted to read a tag according to said embodiment.

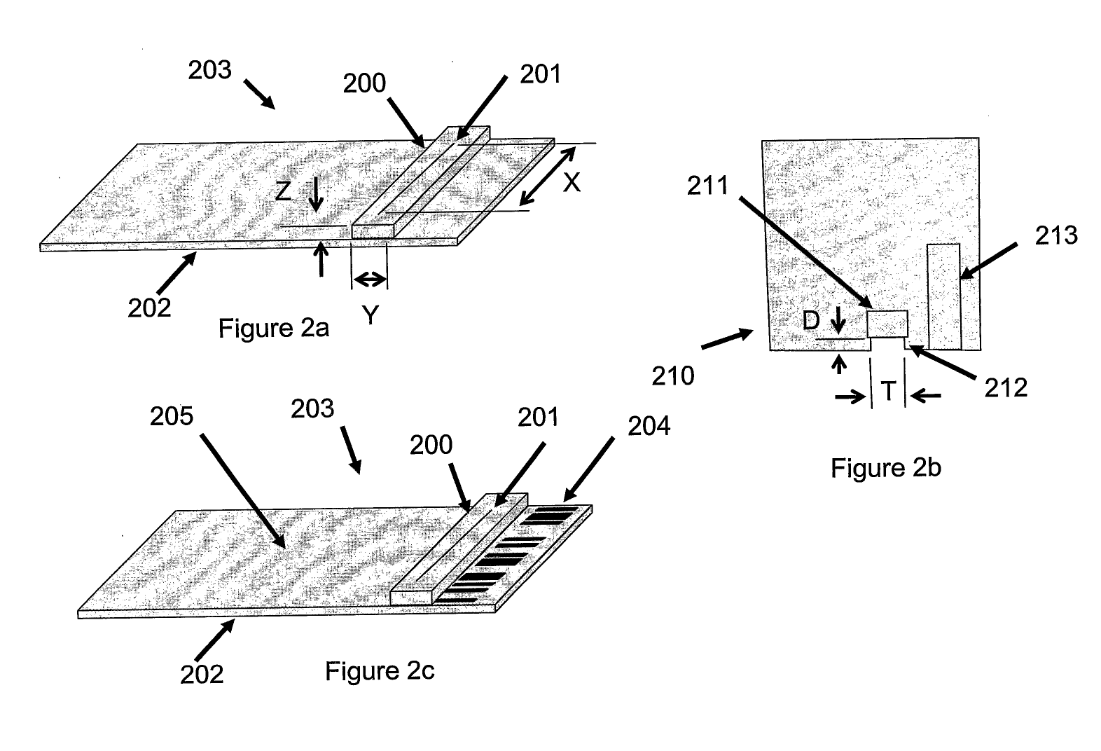

FIG. 2a and FIG. 2c show a tag attached to a label according to one embodiment of the present invention, and FIG. 2b shows a reader adapted to read a tag according to said embodiment.

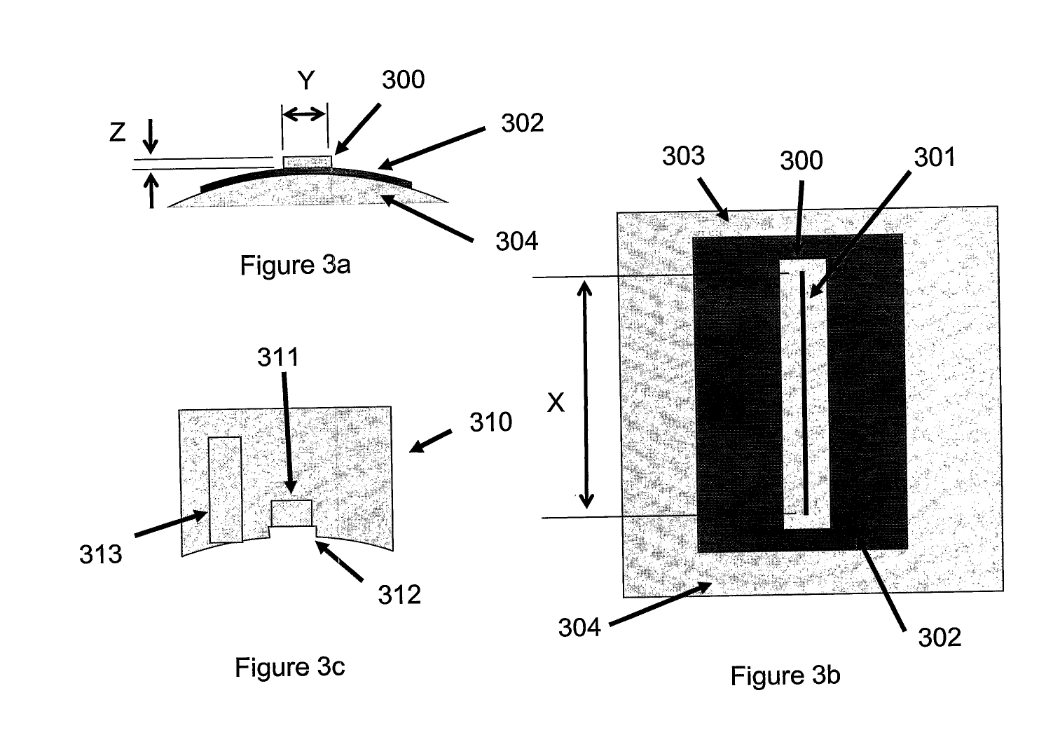

FIG. 3a shows a tag according to another embodiment of the present invention, FIG. 3b shows a plan view of said tag, and FIG. 3c shows a reader adapted to read a tag according to said embodiment.

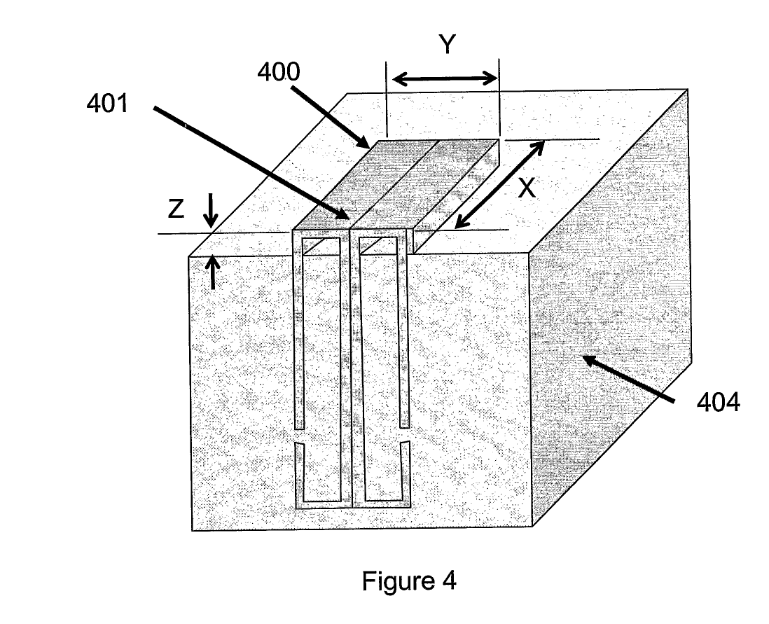

FIG. 4 shows a tag or object according to a further embodiment of the present invention.

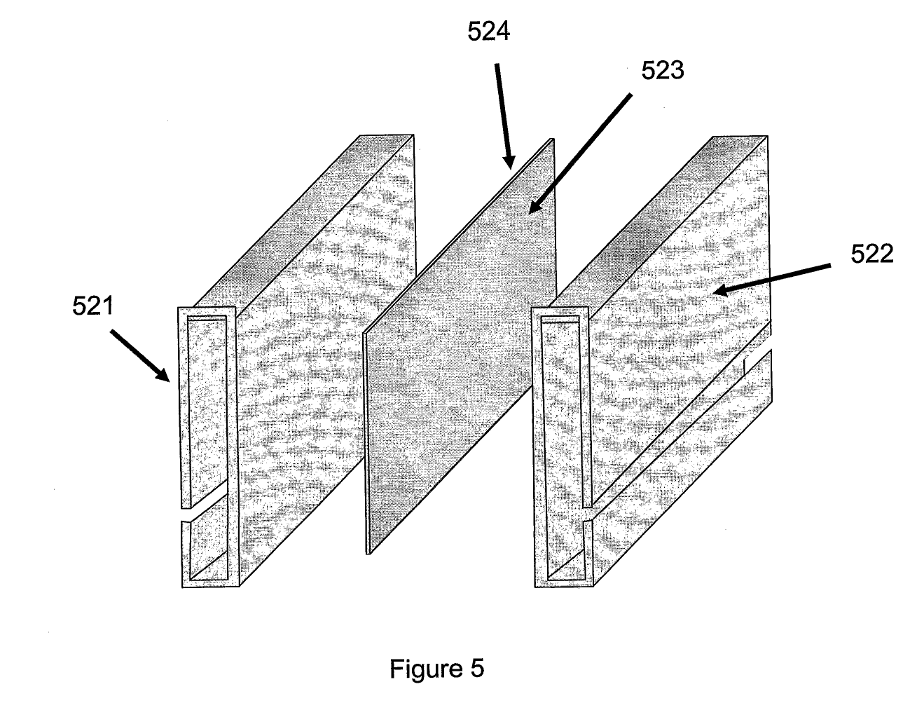

FIG. 5 shows a method of forming a tag according to an embodiment of the present invention.

FIG. 6a shows a method of manufacturing tags according to a further embodiment of the present invention whereas FIG. 6b shows the attaching of such a tag of the invention to an object.

FIG. 7a shows a method of manufacturing tags according to a further embodiment of the present invention, whereas FIG. 7b shows the attaching of such a tag of the invention to an object and FIG. 7c shows a related embodiment of a tag manufactured in the invention.

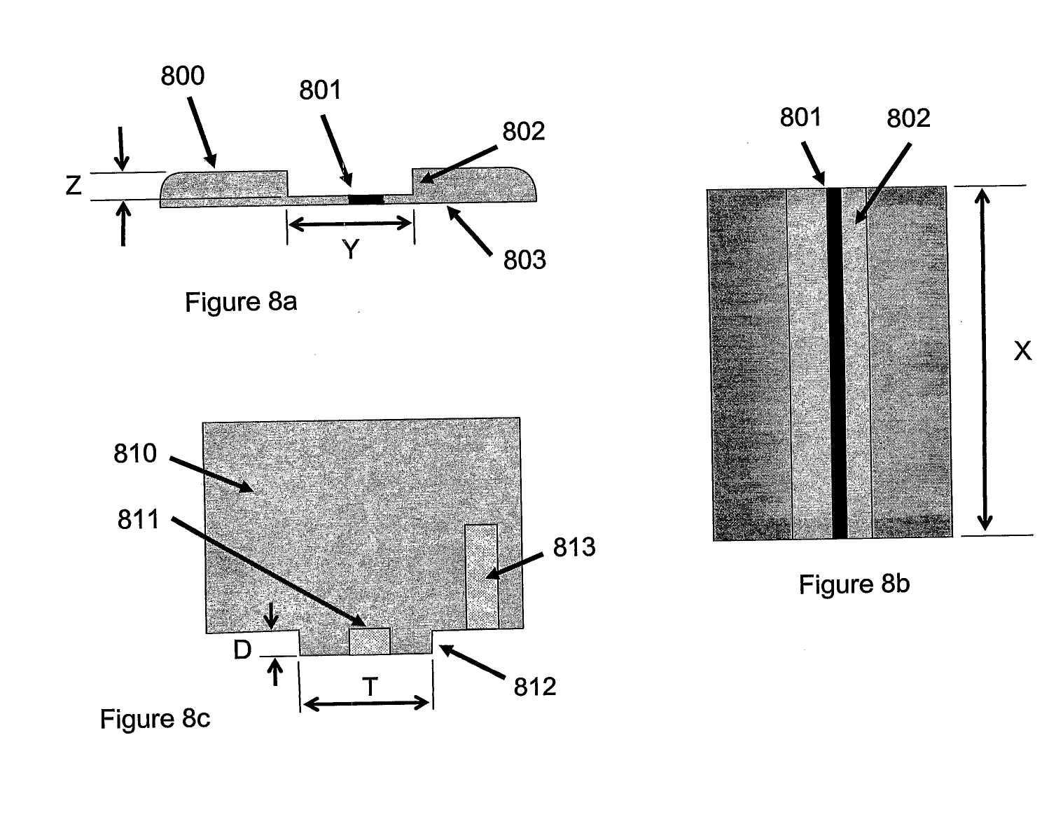

FIG. 8a and FIG. 8b show a tag or an object according to a further embodiment of the invention, and FIG. 8c shows a reader of the invention adapted to read said tag or object.

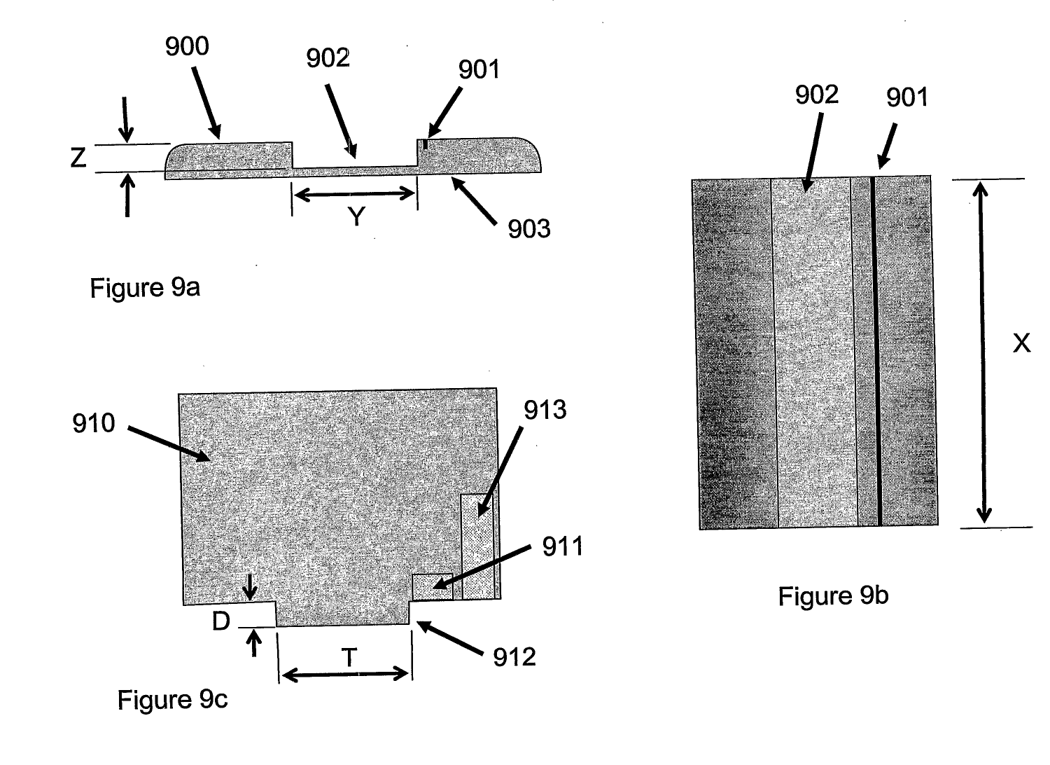

FIG. 9a and FIG. 9b show a tag according to a further embodiment of the present invention, and FIG. 9c shows a reader of the invention adapted to read said tag.

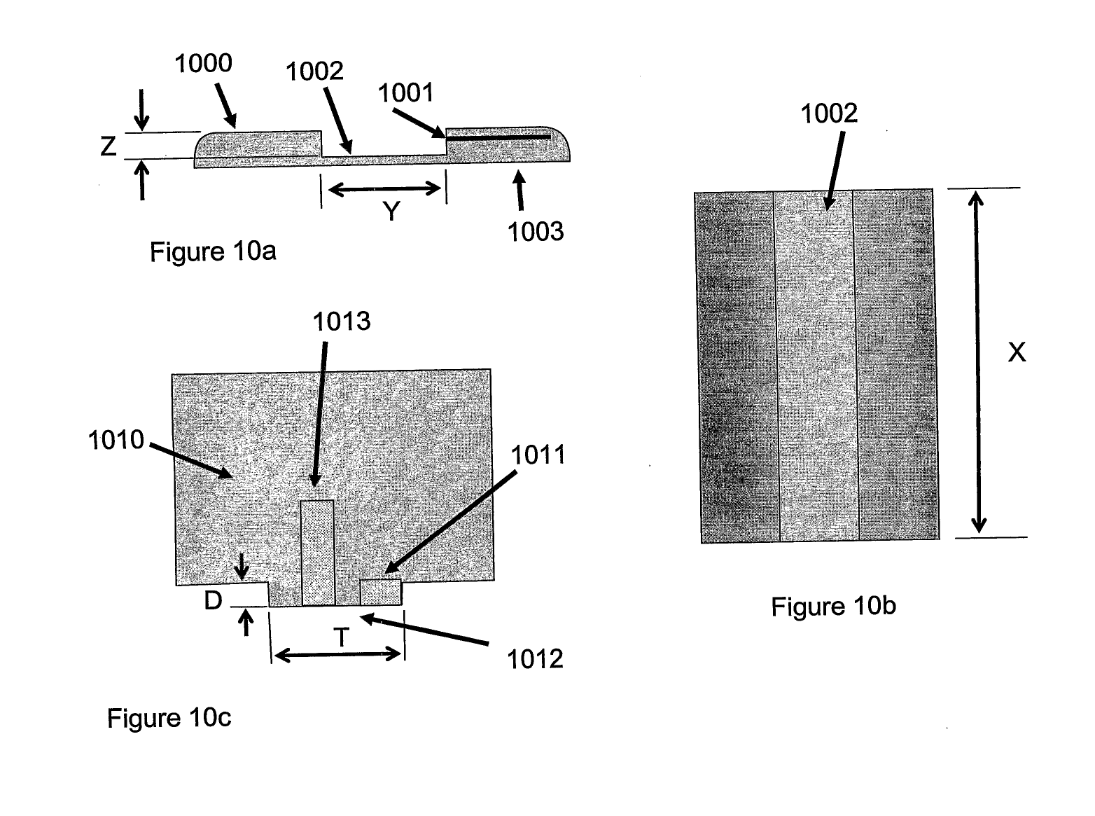

FIG. 10a and FIG. 10b show a tag, according to a further embodiment of the present invention and FIG. 10c shows a reader of the invention adapted to read said tag.

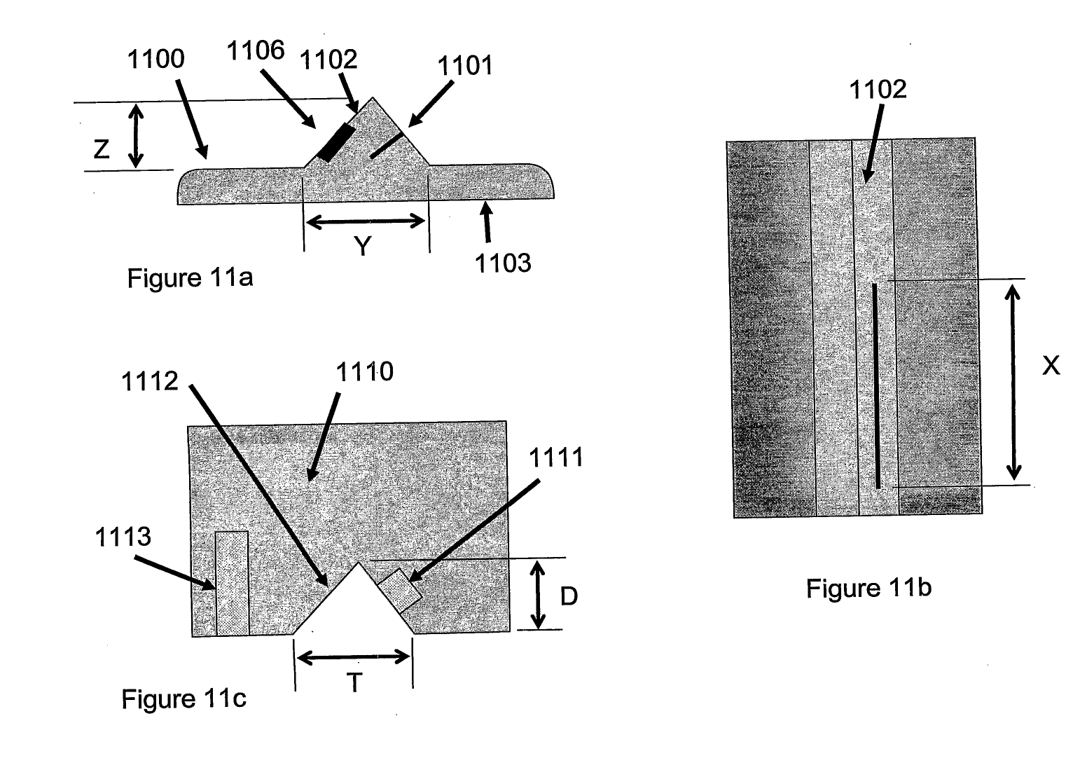

FIG. 11a and FIG. 11b show a tag according to a further embodiment of the present invention, and FIG. 11c shows a reader of the invention adapted to read said tag.

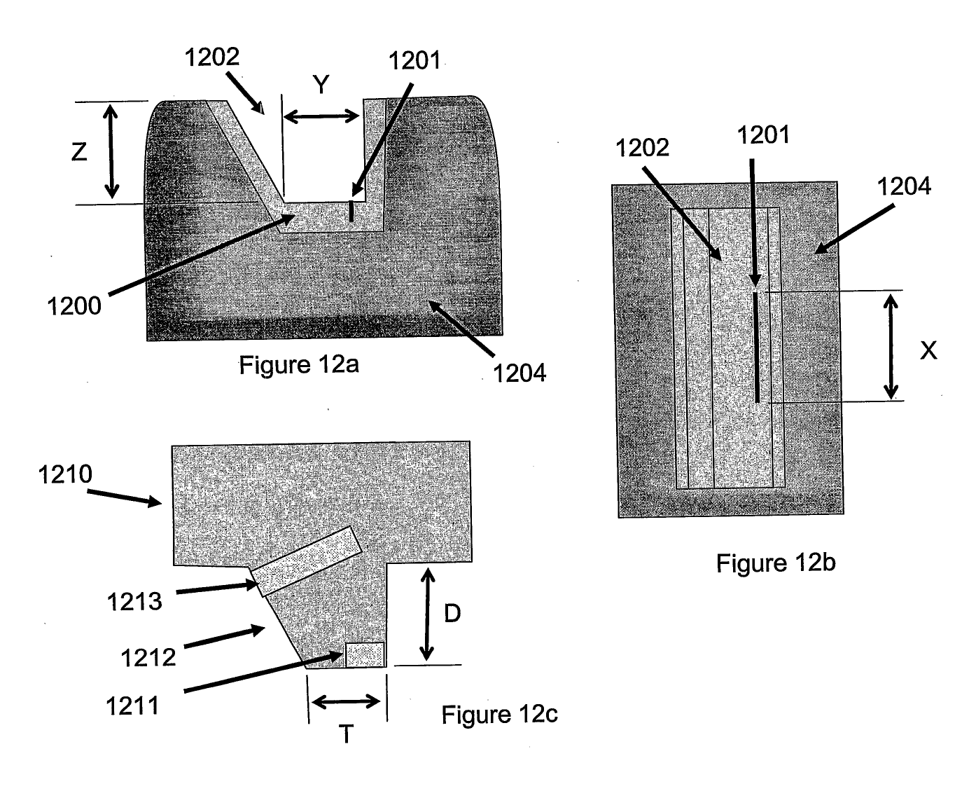

FIG. 12a and FIG. 12b show a tag according to a further embodiment of the present invention, and FIG. 12c shows a reader of the invention adapted to read said tag.

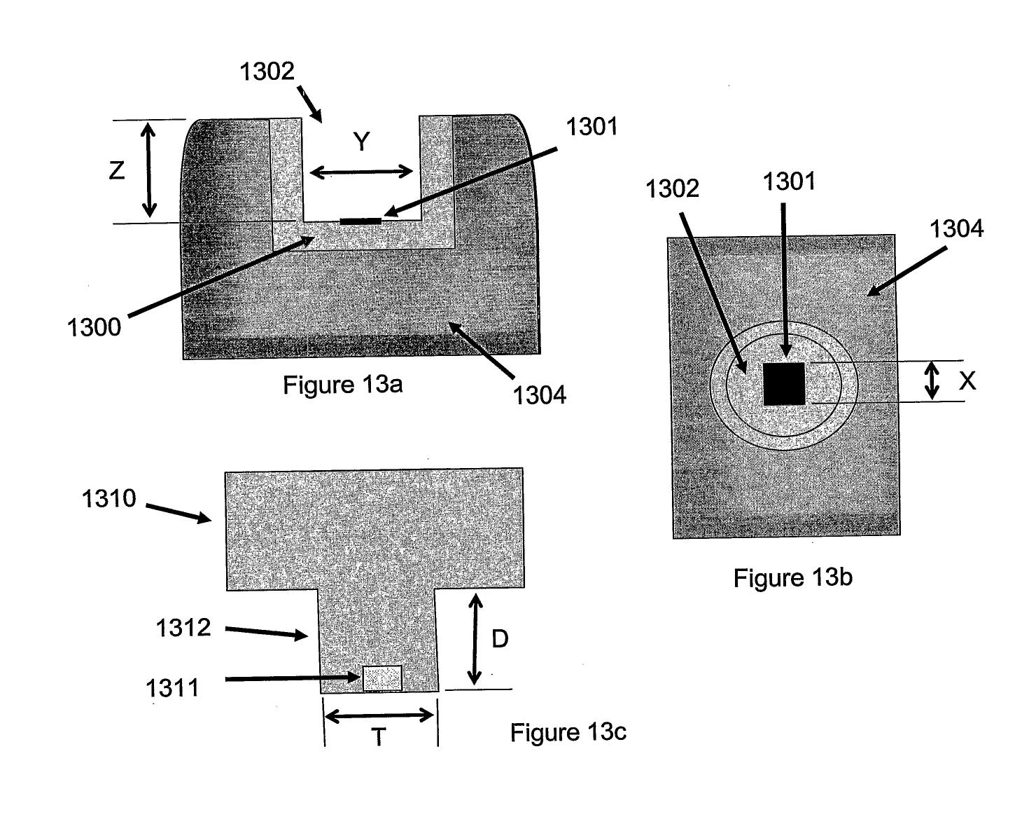

FIG. 13a and FIG. 13b show a tag or an object according to a further embodiment of the present invention, and FIG. 13c shows a reader of the invention adapted to read said tag or object.

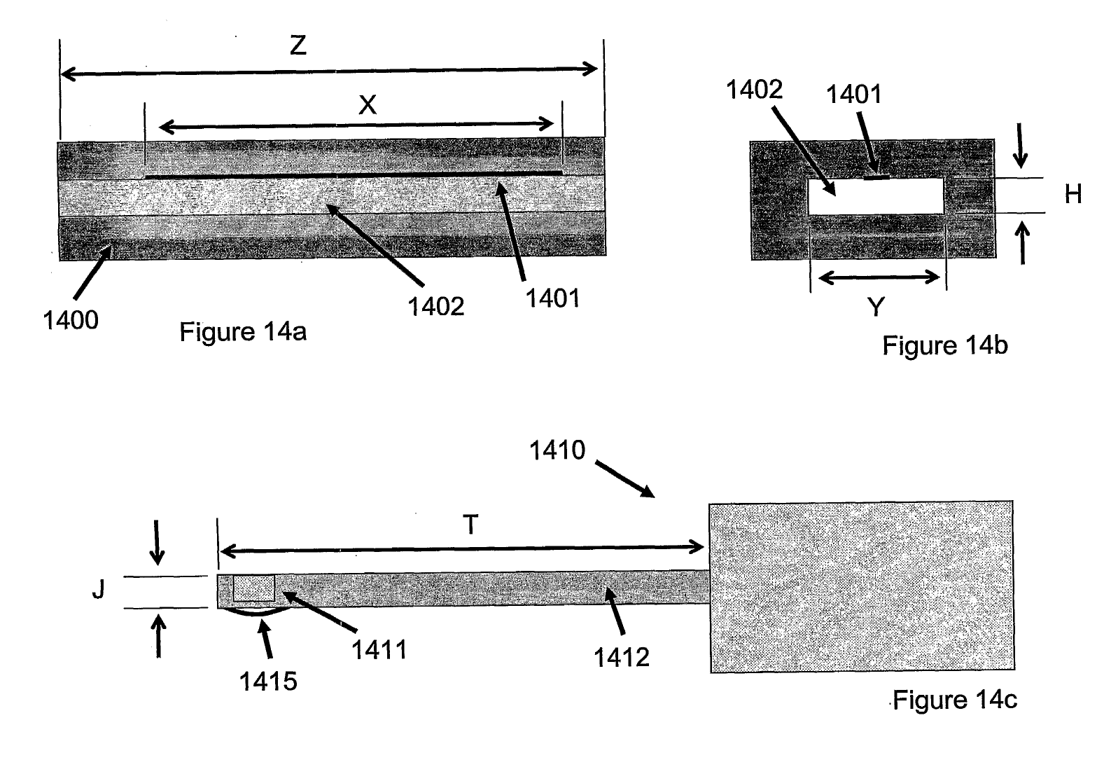

FIG. 14a and FIG. 14b show a tag or an object according to a further embodiment of the present invention, and FIG. 14c shows a reader of the invention adapted to read said tag or object.

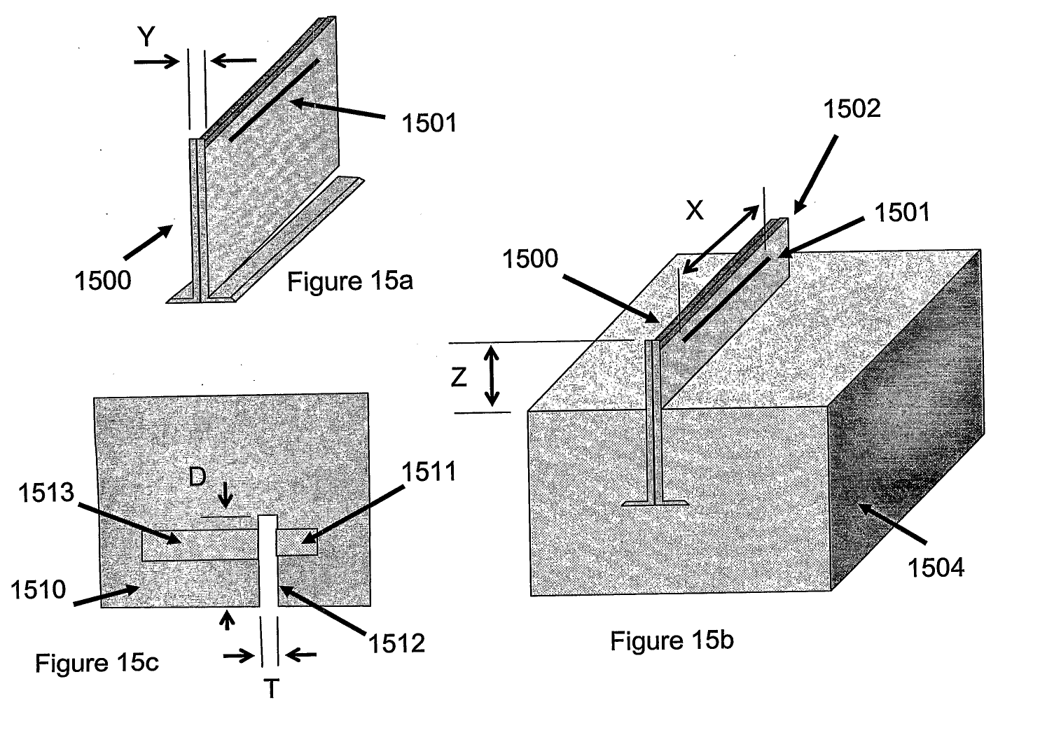

FIG. 15a and FIG. 15b show a tag or an object according to a further embodiment of the present invention, and FIG. 15c shows a reader of the invention adapted to read said tag or object.

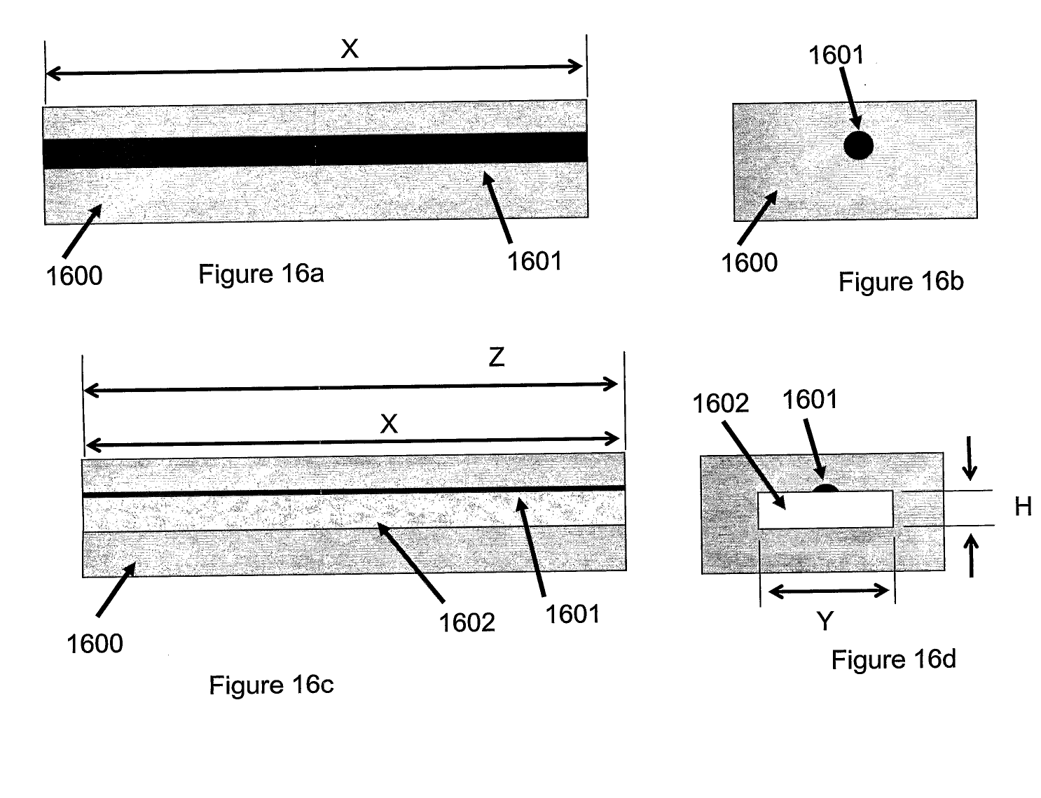

FIG. 16a to FIG. 16d show a tag or an object according to a further embodiment of the present invention.

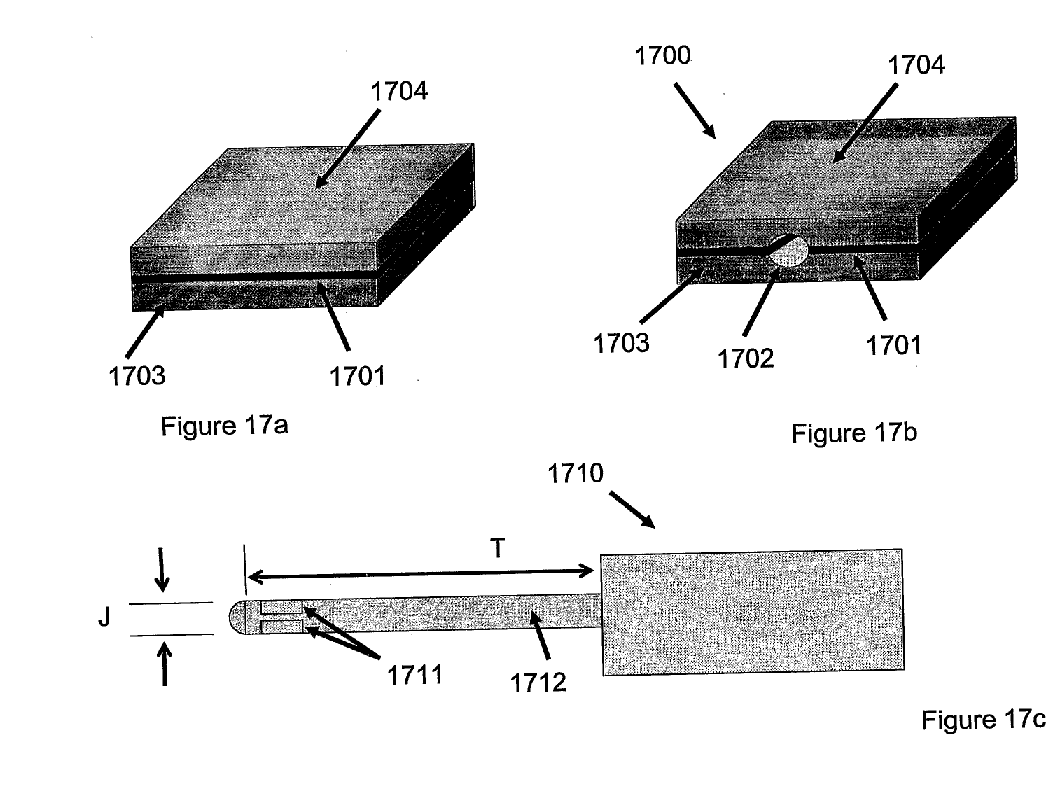

FIG. 17a and FIG. 17b show a tag or an object according to a further embodiment of the present invention, and FIG. 17c shows a reader of the invention adapted to read said tag or object.

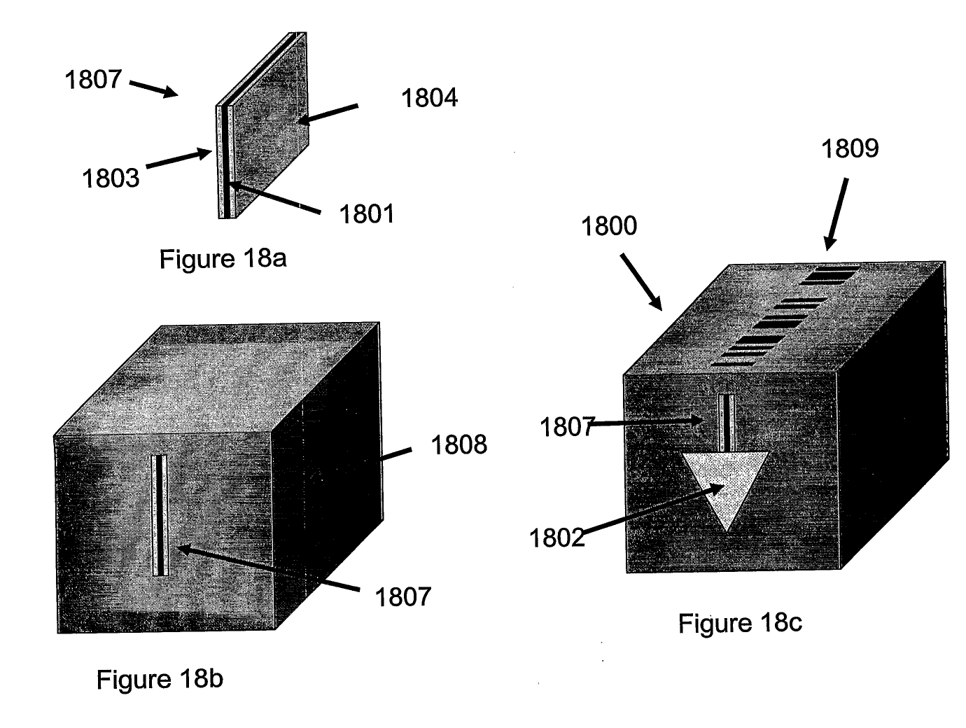

FIG. 18a to FIG. 18c show a tag or an object according to a further embodiment of the present invention.

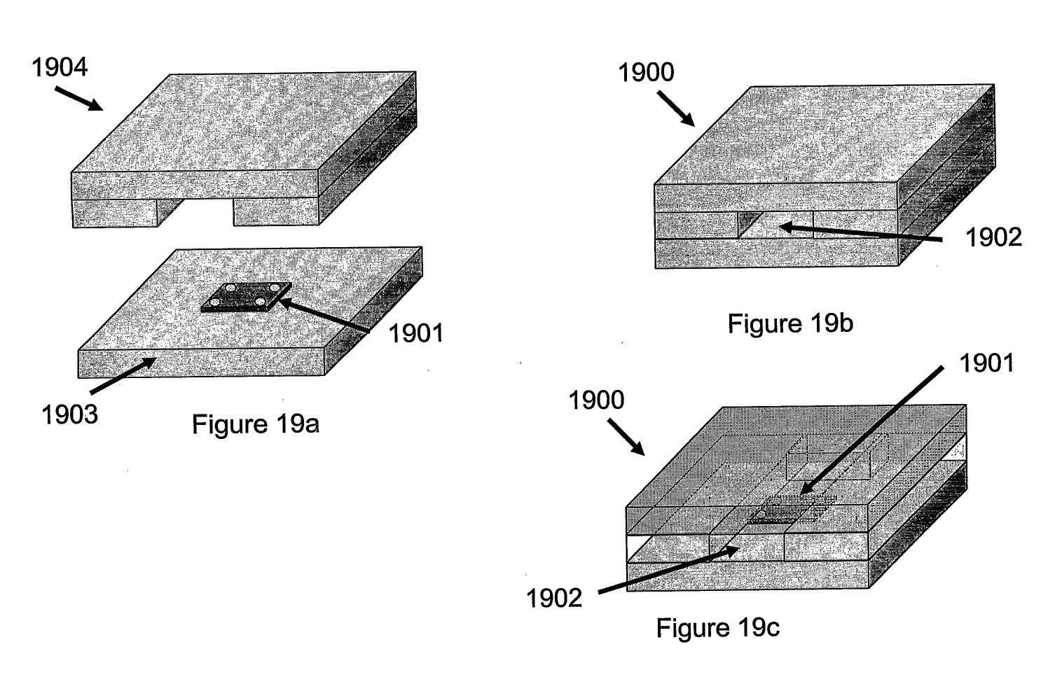

FIG. 19a to FIG. 19c show a tag or an object according to a further embodiment of the present invention.

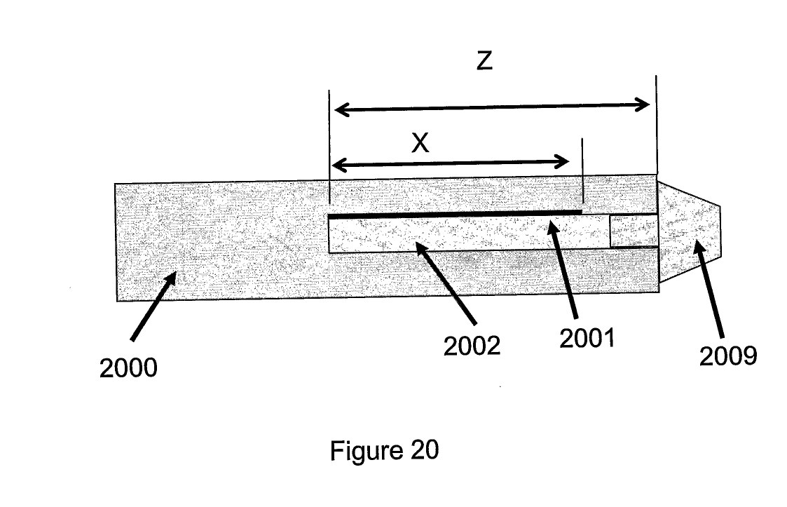

FIG. 20 shows a tag or an object according to a further embodiment of the present invention.

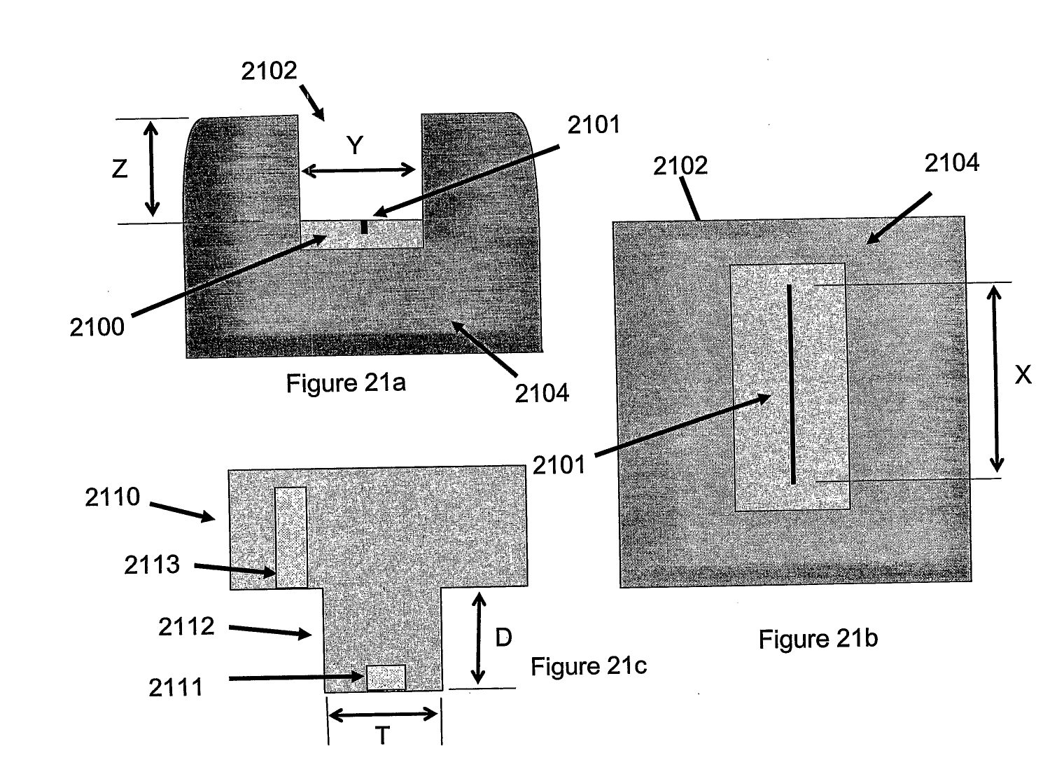

FIG. 21a and FIG. 21b show an object according to a further embodiment of the present invention, and FIG. 21c shows a reader of the invention adapted to read object.

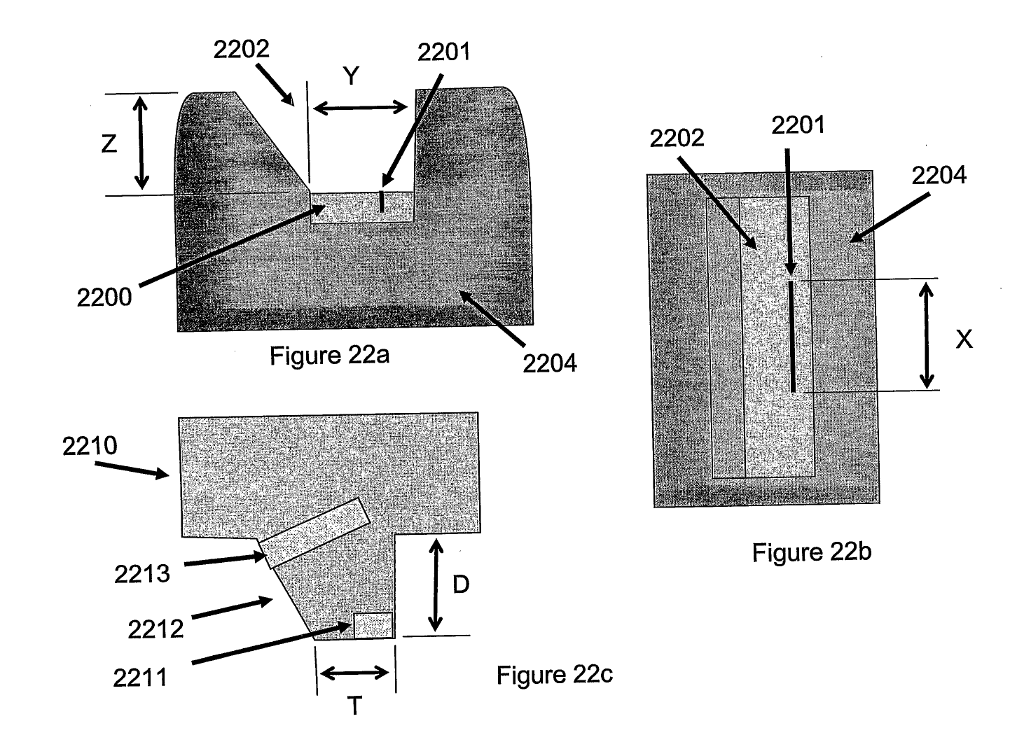

FIG. 22a and FIG. 22b show an object according to a further embodiment of the present invention, and FIG. 22c shows a reader of the invention adapted to read said object.

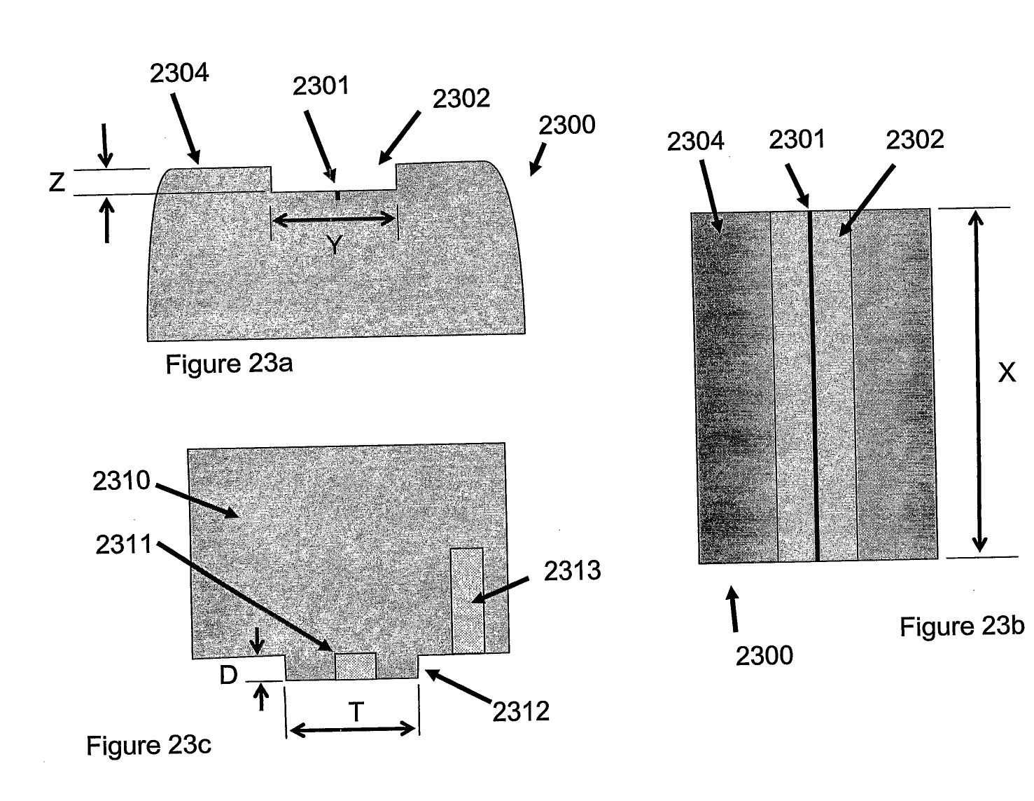

FIG. 23a and FIG. 23b show an object according to a further embodiment of the present invention, and FIG. 23c shows a reader of the invention adapted to read said object.

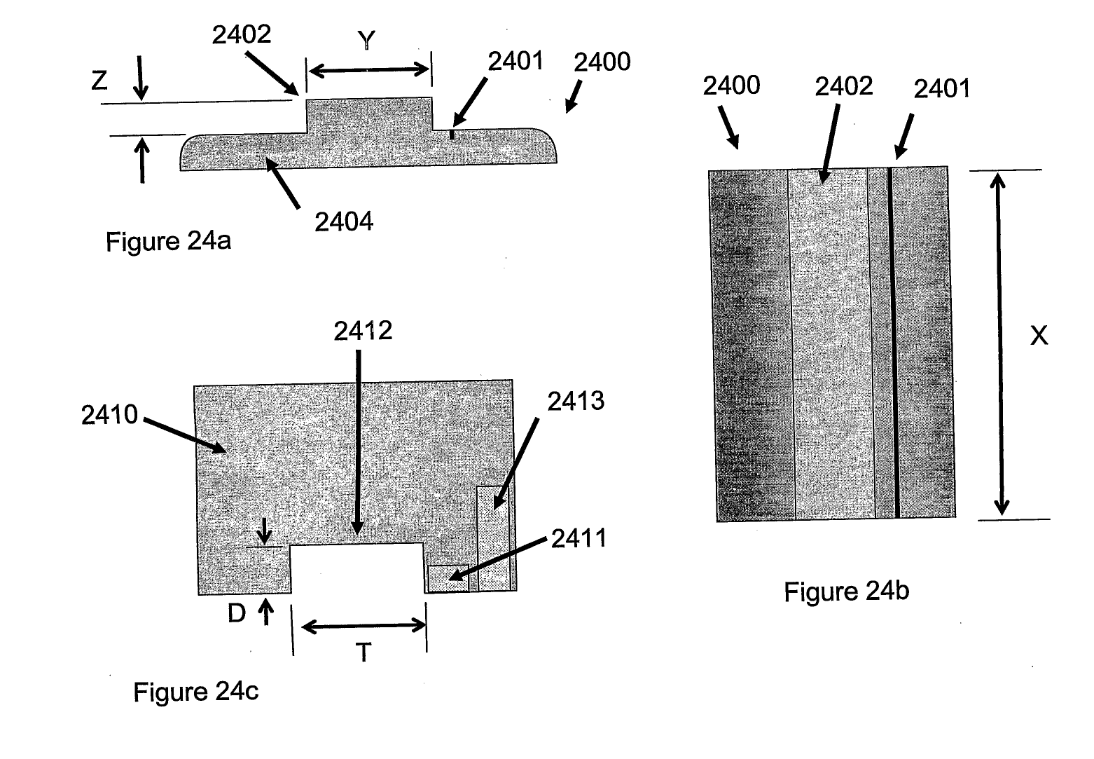

FIG. 24a and FIG. 24b show an object according to a further embodiment of the present invention, and FIG. 24c show a reader of the invention adapted to read said object.

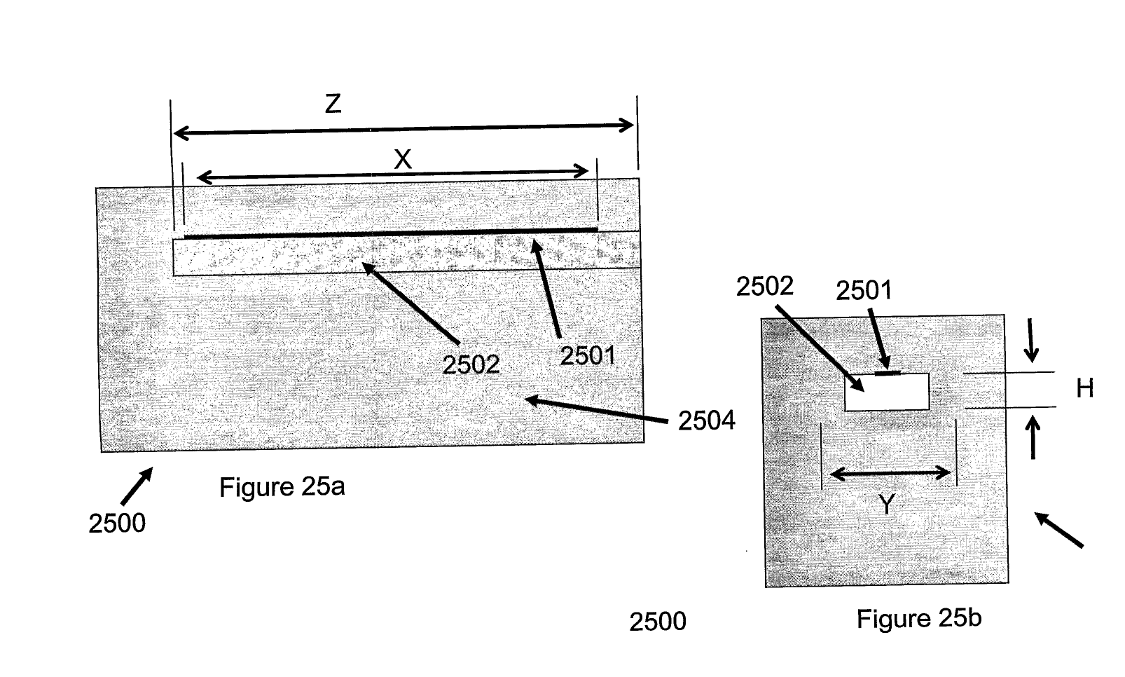

FIG. 25a and FIG. 25b show an object according to a further embodiment of the present invention, and FIG. 25c shows a reader of the invention adapted to read said object.

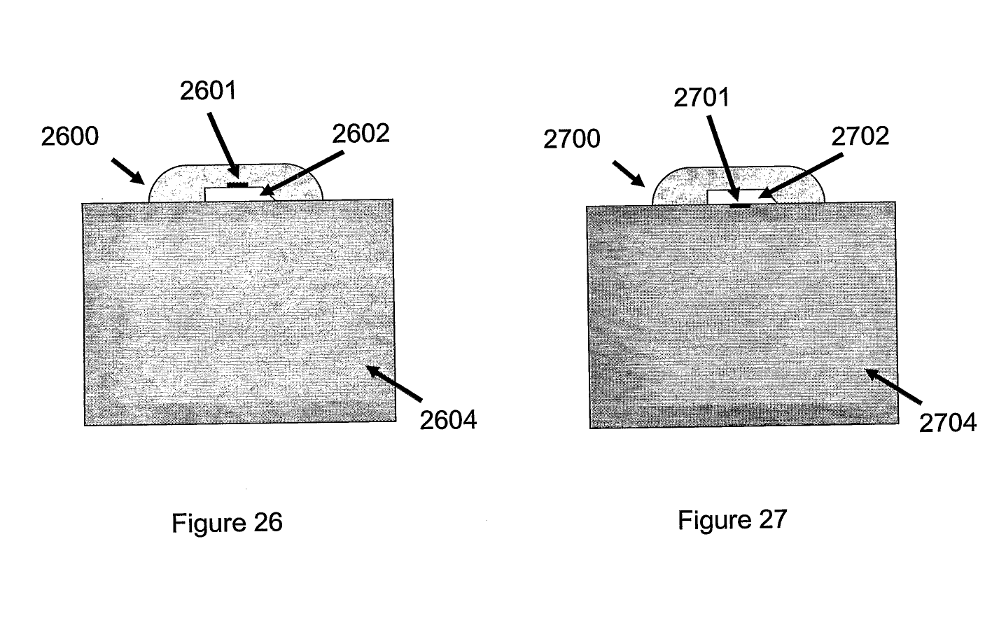

FIG. 26 shows an object according to a further embodiment of the present invention.

FIG. 27 shows an object according to a further embodiment of the present invention.

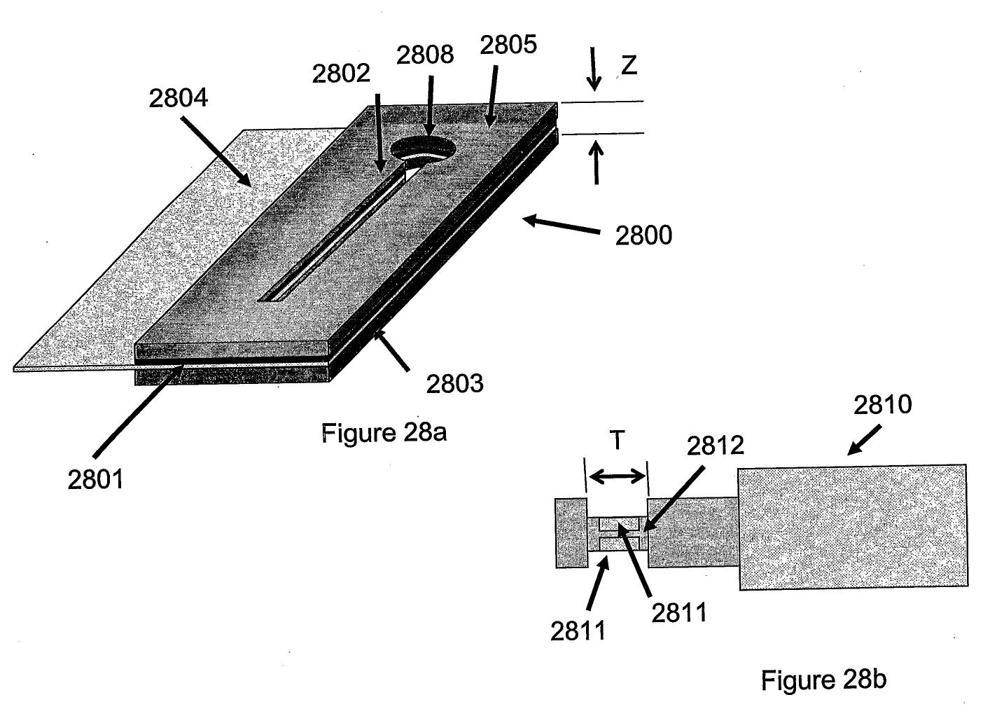

FIG. 28a shows an object according to a further embodiment of the present invention, and FIG. 28b shows a reader of the invention adapted to read said tag or object.

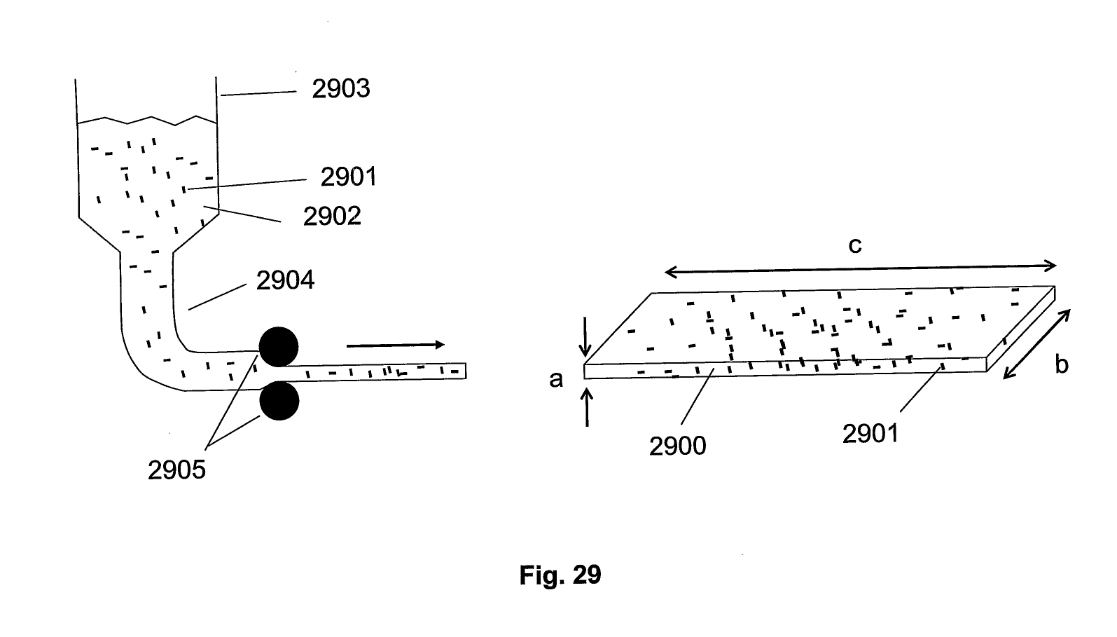

FIG. 29a shows the formation of an identification layer that can be used in a tag or object of the invention, and FIG. 29b shows an isometric view of said identification layer.

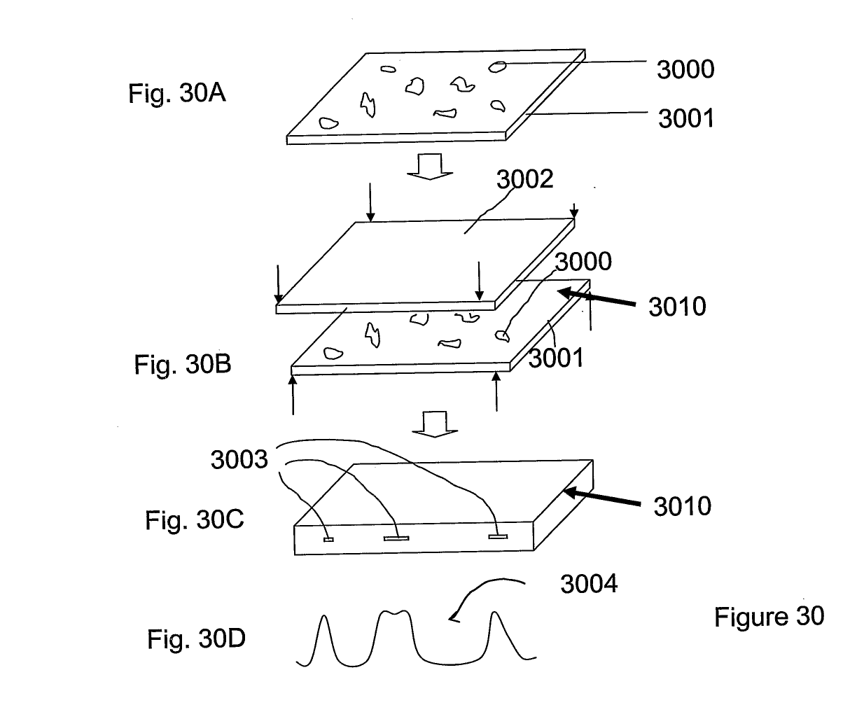

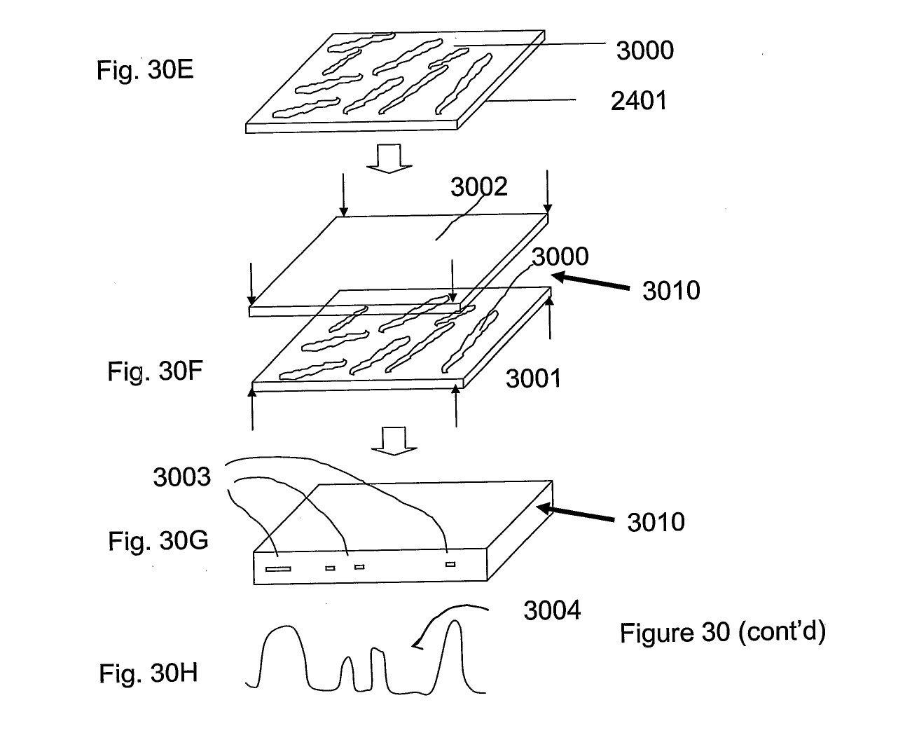

FIG. 30A to FIG. 30H shows views during a method for manufacturing embodiments of identification tags or an object adapted to be identified.

In accordance with the above disclosure provided herein is an identification system for tracking items, preventing counterfeiting, and enabling tamper-proofing, said system comprising: a) a tag or object containing “identification features” (herein “identification features” are understood to comprise for example, but not limited to, an inherently disordered material or composite wherein at least one characteristic signal of the disorder of the material/composite (herein termed “signature”) is meaningfully readable using a reader adapted to read said signature), the tag or object further comprise at least one “engagement track” which allows the reader to be easily physically/mechanically aligned to the identification features, and wherein the tag or object is adapted to be attached to an item of value; b) a reading device that is adapted to physically/mechanically engage with the engagement track and read the tag's signature thereby allowing said signature to be compared with a corresponding characteristic signal of the disordered material/composite that had previously been read from the identification features (herein termed a “reference signature” or a “pre-stored reference signature”); c) optionally a data storage device wherein the reference signature is stored (herein a “data storage device” refers to any machine-readable means of storing data, e.g. a hard disc, magnetic tape drive, optical storage disc, memory chip or even conventional optical means such as a 2D barcode or bitmap).

Also provided are tags or objects that can be easily attached to items of value, particularly items of value that comprise planar and/or curved surfaces and may not have readily available edges or corners on which to make reference.

FIG. 1d shows a tag 100 according to one embodiment of the invention. The tag contains a track or layer of identification features 101. The tag is adapted to be attached to an item of value 102 by, for example, having an adhesive layer, or through being able to be heat bonded, or by having a shape or form-factor providing for a physical means of embedding some part of the tag inside the item of value. In this case the tag itself forms the engagement track, since it is made from a thick rectangular-section material with well-defined edges. This engagement track is essentially complimentary in shape to a part of a reading device that reads the identification features located in the identification layer via the reading track. In the tag either the thinnest dimension or one of the main surfaces can be exposed for reading of the identification features

FIG. 1e shows a cross-sectional view of a reader 110 adapted to read the identification features of the tag shown in FIG. 1d. The reader comprises at least one reading element 111 that is suited to reading the tag's signature (for example, if the identification features comprise randomly distributed magnetic particles, the read element can be a magnetic sensor such as a magnetic read head used, for example, in magnetic data storage tapes, VCRs, floppy discs or hard discs, whereas if the identification features comprise randomly dispersed optically emitting particles then the read element can be an optical sensor or optical detector). The reading element 111 is positioned a known fixed distance from one edge of groove 112 that is designed to engage with the engagement track formed by the tag 100 on the object. The reading element 111 is positioned at the known fixed distance from the edge of the engagement element so as to align with the tag's identification features and thereby read its signature. In the embodiment shown the reader can be moved with respect to the tag (or vice versa, for example by holding the reader with a hand and moving the reader along the tag), or the read element can be moved across the identification features using a mechanical actuator, or the read element can be such that it is able to read sufficient information without being moved with respect to the identification features (by virtue of comprising a liner or area array of sensors, for example an optical imaging device such as a charge coupled device (CCD) array is able to image an area without being moved across the surface).

In this embodiment, where the engagement element is a groove, it is designed so that its width “T” is equal to or slightly greater than the width of the engagement track “Y”, thereby allowing it to engage with the engagement track. In certain cases it may be advantageous to have width “T” smaller than width “Y”. In these cases either the engagement track or the engagement element should be elastically deformable so that meaningful mechanical engagement can still take place. If needed the reader may include one or more position tracking elements 113. For example if during reading the signature the reader is moved with respect to the tag (or vice versa) to achieve repeatable readings it may in some circumstances be important to accurately track the relative displacement between the tag and reader. Furthermore it may be advantageous to have at least a marking on the tag to indicate the start point and/or end points where the readings should begin/end.

The position tracking element may, for example, be an optical position sensor such as those used in optical mice for computers. If the position sensor is used to identify the start and/or end points of the reading (and possibly position markings in between), then we have found an optical barcode sensor to work well. It is clear to the person skilled in the art that other sensors for sensing position can also be used, e.g. the sensor may be a magnetic sensor tracking magnetic markings/features designed to identify the position. Furthermore, it is sometimes advantageous to use a combination of more than one position sensor, for example a barcode sensor to identify the start and end points of the reading and an optical position sensor (such as used in a computer mouse) to track the distance moved between the markings.

In general, the dimensions of the engagement track are chosen such in the present invention that they are sufficient to allow good physical/mechanical engagement with the engagement element. Consequently when engaged, the distance to which the engagement track protrudes into the engagement element (or vice versa as shown in later embodiments), hereinafter referred to as the “engagement distance” must be at as great as possible for the particular application but is typically be at least about 50 micrometers. However, it can also be at least 150 micrometers or more. This means that for the embodiment shown in FIG. 1a, the height “Z” of the engagement track is at least 50 micrometers, and correspondingly, the depth “D” of engagement track 112 is also at least 50 micrometers. For structural stability in the embodiment shown in FIG. 1 it is desirable that Z≦10Y or more preferably that Z≦Y. The length of the identification features to be read is marked “X”.

The tag 100 as shown in FIG. 1d may have additional information printed on it or embedded into it. For example a magnetic strip (as used in credit cards) could be embedded into the tag, or company logos or other security features such as holograms or barcodes could be printed on the surface of the tag. The information “written” (e.g. written using magnetic, optical or other means) can contain information about the tag's signature. For example an encrypted 2D barcode could be written on the surface of the tag and the encrypted information in the barcode can contain the tag's reference signature. The reader can then read tag's signature and the barcode simultaneously and compare the signature with the reference signature in the barcode.

FIG. 2a shows a further embodiment of the present invention. Here a tag 200 containing identification features 201 is bonded to a label 202. Once the tag and label are bonded, the bonded unit forms an object 203 according to the invention. Again, the tag 200 that contains the identification features forms an engagement track on a surface of the label. The engagement track is Y wide and Z tall and is adapted to engage an engagement element of a reading device.

FIG. 2b shows the cross-sectional view of a reader adapted to read the object shown in FIG. 2a. The reader 210 comprises at least a reading element 211 and an engagement element 212 designed to engage the engagement track shown in FIG. 2a. The engagement element has the dimensions D and T as shown in the figure. An optional position tracking element 213 is also shown. The dimensions Z and D are again at least about 50 micrometers in order to fulfill the criterion that the engagement distance be at least about 50 micrometers. The dimension T is greater than or equal to the dimension Y in order to allow mechanical engagement.

As with the case of the tag shown in FIG. 1d, the tag 200 or label 202 shown in FIG. 2a may have additional information printed on them or embedded into them. This is illustrated by the embodiment of FIG. 2c, in which a 1D barcode 204 is arranged substantially parallel to the tag arranged on the label 202. This is also applicable to all subsequent embodiments described herein. Note that the item of value to which the object (label) is to be attached is not shown in FIG. 2. In this context it is also noted that the barcode 204 on the label 200 can serve as the alignment or positional marking for the tracking element 213 of the reader 210. As explained above in context with the embodiment of FIG. 1, the tracking element 213 can be an optical sensor. Alternatively, if instead of a barcode 204 a magnetic strip or randomly distributed magnetic particles in a hair-like form as shown in FIG. 7 are used as alignment or positional marking, the tracking element 213 can be a magnetic sensor as also illustrated with reference to FIG. 1. Thus, in the present invention the alignment marking can generally be a second set of identification features.

FIG. 3 shows an embodiment where an object 303 and reader 310 are adapted for use on items of value 304 with curved surfaces. FIG. 3a shows a cross-sectional view of the tag while FIG. 3b shows a plan view of the tag. The tag 300 containing identification features 301 is bonded to a label 302. Once the tag and label are bonded, the bonded unit forms an object 303 adapted to be identified according to the invention. The object 303 is adapted to be bonded to an item of value 304 with a curved surface. Again the tag 300 itself forms the engagement track. The reader 310 comprises at least a reading element 311 and an engagement element 312 designed to engage the engagement track 300. An optional position tracking element 313 is also shown. The surface of the reader 310 directly adjacent to the engagement element 312 may be curved (as shown in FIG. 3c) to increase its mechanical stability during engagement as the identification features are read.

FIG. 4 shows a further embodiment of the present invention. Here a tag 400 containing identification features 401 is adapted to be attached to an item of value 404 by being embedded into the item (as shown in the figure). Alternatively, FIG. 4 shows an object adapted to be identified in which an identification layer is arranged such that an engagement track is formed in the object. The engagement track (which in this embodiment is a portion of the tag itself or of the identification layer) is Y wide and Z tall. Here the dimension Z is measured as the height of the engagement track that is available to engage with the engagement element (after the tag or identification layer is embedded) in order to allow the identification features to be read. Also in this embodiment, the dimension Z is usually at least 50 micrometers. A reader adapted to read tag 400 is not shown as it is similar in appearance to the readers already shown, e.g. it has an engagement element wide enough to engage with the engagement track i.e. the engagement element would be at least as wide as dimension Y.

FIG. 5 shows one method by which a tag such the one shown in FIG. 4 can be made. The components of the tag are shown in exploded form, i.e. prior to being bonded together to form the tag. Here two pieces of rectangular-section stock material 521 and 522 sandwich a film of material 523 containing identification information. As an example, if the identification features are to be magnetic, the material 523 comprises a non-magnetic matrix material containing randomly dispersed magnetic particles. The identification features are read by the reader's reading element by bringing the read element into close proximity to the exposed surface 524 of material 523. The stock 521 and 522 can have virtually any shape/section that allows for easy bonding, engagement of the reader, and reading of the signature. Furthermore the stock 521 and 522 can be made from a wide variety of materials depending on the application. For example, plastic is useful for embedding in a polymeric object such as thick-walled pipe, an automotive bumper or an item of plastic moulded furniture. Metal is suitable, for example, for use in automotive castings, metallic boxes and chasses, or machinery components.

FIG. 6 shows one method by which a tag or object such the ones shown in FIG. 1d, FIG. 2 and FIG. 3 could be made. This tag is also termed an “accommodating layer” tag. FIG. 6a shows the first part of the process in a roll-to-roll setup. Here periodic through holes 603 are cut as accommodating recess into a film of material 601 (the film is initially in a roll form 600) that serves as accommodating layer in the tag. It has been found that the through hole cutting can be done using a laser 602, for example. If polyethylene terephthalate (PET) films are used a carbon dioxide (CO₂) laser is able to cut accurate, consistently formed, holes at acceptably high speeds. Thereafter a cover film in form of a film 604 is unrolled from its roll 605 and bonded to the film 601 (accommodating layer), closing the one opening of the through holes. The through holes are then filled from the other side with precursor material 607 which is dispensed from a dispensing syringe 608. If the identification features are to be read magnetically then the precursor material 607 may, for instance, be a non-magnetic polymeric adhesive or ink containing randomly dispersed magnetic particles. Illustrative examples of constituents of suitable adhesives and inks include conventional curable epoxide composition, (meth)acrylate compositions or polysiloxane compositions, including those compositions that are described in US patent applications 20050245633 and 20050245634. In cured form such inks yield a mechanically stable, wear resistant and chemically inert matrix that ensures that the identification features are safely embedded therein and that the accommodating layer is self-supporting and, if desired, can be used without any further layer or base that supports the accommodating layer. The precursor material 607 can be forced into the holes using a squeegee or blade 609, for example. The precursor-filled holes are shown as 610. At this stage the precursor is cured, thereby fixing the position of the randomly distributed particles embedded in the tag. Depending on the precursor, curing is initiated by heat, infra-red (IR) light, ultra-violet (UV) light or other curing mechanisms (for example electron-beam induced cross-linking). The case shown in FIG. 6a shows a curing element 611 (which could be a heating lamp or UV light, for example). If appropriate, the film is trimmed to size, using slicing blades 612, for example. The tag material is now made and it is cut into sections of suitable size for the application. In illustrative embodiments of such “accommodating layer” tags, the accommodating recess may have a length of about 10 mm, a width of about 0.25 mm and a depth of about 0.5 mm. Thus, the identification layer formed in the accommodating recess, once the recess is filled with randomly distributed material, has a hair-like, strand-like or rod-like shape with two dimensions (for example dimensions a and c when referring to FIG. 1a) being very similar. Thus, it is understood that the term “identification layer” also comprises such a hair, strand or rod-like configuration.

FIG. 6b shows a tag 620 made from a section of tag material made using the process shown in FIG. 6a. The precursor-filled grooves constitute the identification features 621 that are to be read by the reader. The tag further comprises a cover layer 622 made from the film 604, that now serves to further protect the identification features from environmental conditions (such as moisture, corrosive fluids, etc) as well as mechanical wear or abrasion. If the cover layer/film is made from a polymeric material, it can be advantageous to have this layer/film coated with a thin layer of metal in order to prevent moisture and other chemicals from diffusing through the cover film. The surface of the tag that is opposite the cover layer preferably has a film of adhesive on it to allow it to be bonded easily to surfaces. This tag can be used as it is, as shown in FIG. 1a, where the tag has been bonded to an object of value by contacting the adhesive coated face with the object of value. Alternatively, the tag may be used in conjunction with another component (or other components), e.g. a label 623, to form an object according to the invention (examples of such objects are shown in FIG. 2 and FIG. 3). In the embodiment shown in FIG. 6b, the tag has been turned over so that the adhesive coated face contacts with the label, thereby adhering the tag to the label and the cover layer now forms the top face of the tag—the bonded unit forms an object according to the invention.

If the identification features consist of magnetic particles, the individual particle's contribution to the signature will be influenced by the position of the particle (not just along the length of the hole 603 but also how far the particle is beneath the surface and its spatial orientation) within the hole 603. This adds to the complexity and statistical variation of the identification features and hence adds to the complexity and “uniqueness” of the signature.

In the case of a signature derived from a magnetic signal, the cover layer/film 604 should be as thin as possible so as to enable the magnetic field to be easily read by the reading element, and for the position of that field to be clearly resolved (and not dispersed by the distance to the reading element). When using highly magnetic particles (such as microscale particles made from NdFeB alloys) it was found that a polymer film of 25 to 100 micrometers thick is workable—thick enough to be mechanically stable in a roll to roll lamination process, and thin enough to enable the signature to be detected. The optimum thickness of the cover film depends on a) the type of magnetic particles used (e.g. their magnetic field strength, and size of the particles), b) the detection mechanism (for example if magneto-optical methods are to be used, a thick transparent film would be acceptable, if however a standard magnetic field sensor or magnetic read head, such as is used in data-storage tapes, is used then the film must be kept as thin as possible, but need not be transparent) and c) the environmental conditions during the tag's use (e.g. if the tag is subject to mechanical abrasion, corrosive substances, needs to be functional for a long period of time etc then the cover layer needs to be appropriately robust). The optimum thickness can be easily determined experimentally.

The lengths of the perforations or holes 603 can be tuned to the length of the final tag 602. The length of an individual hole should preferably be less than the length of the tag, so that the tag remains supported and mechanically stable. If the ink is viscous and the holes are very short or have a small diameter, if circular, the filling process of the ink that forms the identification features can become problematic. For squeegee-ing viscous epoxy-based inks, a hole (accommodating recess) length of between 1 and 10 millimeters with a spacing of 0.5-1 millimetre between holes was found to be suitable, for a tag of 10-100 millimeters in length.

From the foregoing discussion it is clear that in the process shown in FIG. 6, the combined thickness of film 601 and film 604 when bonded together should be at least 50 micrometers so as to provide the necessary height for the engagement track. It is also clear that the use of optical inks, e.g. squeegee-ing transparent inks containing fluorescent particles into the holes is also encompassed in such a tag of the invention. It is for example also possible to fill the holes 603 with an ink by using an inkjet or spray system.

FIG. 7 shows a further method by which a tag or object such the ones shown in FIG. 1, FIG. 2 and FIG. 3 could be made. FIG. 7a shows the first part of the process in a roll-to-roll setup. Here a precursor adhesive or ink 707 (which can be the same of the one for the manufacture of the accommodating tag illustrated in FIG. 6) is applied onto a film of material 701 (the film which acts as the base substrate in the tag is initially in a roll form 700). The precursor adhesive or ink is dispensed from a dispensing syringe 708 or any other suitable means of applying adhesives or ink, e.g. ink jet printer, intaglio printer etc. Also such an identification layer, once formed, can have, but is of course not limited to, a hair-like shape with a width of the adhesive or ink of about 0.25 mm. If the identification features are to be read optically then the precursor material 707 may, for instance, be a transparent polymeric adhesive or ink containing randomly dispersed fluorescent or phosphorescent particles. After dispensing the precursor ink is cured. Depending on the precursor, curing is initiated by simple drying, heat, ultra-violet (UV) light or other curing mechanisms (such as electron beam induced cross-linking). For clarity, FIG. 7a does not show the curing means. If necessary the film is trimmed to size, using slicing blades 712, for example. The tag material is now made and it is cut into sections of suitable size for the application.

FIG. 7b shows a tag 720 made from a section of tag material made using the process shown in FIG. 7a. The cured precursor constitutes the identification features 721 that are to be read by the reader. The surface of the tag that is opposite where the precursor ink 707 was dispensed may have a film of adhesive on it to allow it to be bonded easily to surfaces. This tag can be used as it is, as shown in FIG. 1a, where the tag has been bonded to an object of value by contacting the adhesive coated face with the object of value. Alternatively, the tag may be used in conjunction with another component (or other components), e.g. a label 723, to form an object according to our invention (examples of such objects are shown in FIG. 2 and FIG. 3). In the embodiment shown in FIG. 7b, the adhesive-coated face of the tag contacts with the label, thereby adhering the tag to the label—the bonded unit forms an object according to the invention.

From considering these figures and the foregoing discussion, it is again clear that the film 701 should typically be at least 50 micrometers or more thick, so as to provide the engagement track. Moreover, although the example was given of inkjet printing a track that creates an optically detectable signature, printing magnetic ink can also be applied in this case.

FIG. 7c shows a tag 720 made from a section of tag material made using the process shown in FIG. 7a. The cured precursor constitutes the identification features 721 that are to be read by the reader. Here the tag has been additionally marked with a 1D barcode 730. It will be appreciated that the marking can be any desired marking, e.g. an optical marking such as a hologram, a 2D barcode, a logo or other artwork, a serial number, timing marks, or a magnetic marking such as a magnetic ink, a magnetic strip (such as used in credit cards). Furthermore a chip based identifier can (also) be attached or embedded into the tag. Suitable chip base identifiers include a radio frequency identification (RFID) chip or a contact-based IC chip such as ones used in smart cards. The marking can also be covert, for example it can be a chemical or molecular marker that it hard to detect unless the person knows what to look for.

FIG. 8 shows a further embodiment of the invention. FIG. 8a shows a cross-sectional view of an identification tag or an object adapted to be identified. The tag or object 800 contains identification features 801 that are arranged in an identification layer. Either a main surface (as shown in FIG. 8a) or the thinnest dimension of the identification layer contained in the tag or object can be exposed for reading of the identification features. The tag or object further comprises an engagement track 802. In this embodiment the engagement track is a groove, channel, or slot in the tag or object. The depth of the engagement track is given by dimension “Z” and its width by dimension “Y”. FIG. 8b shows a plan view of the tag shown in FIG. 8a. As shown in FIG. 8b the identification features (dimension “X”) may run the entire length of the engagement track—although as before, this is not necessary. One (or more) face 803 of the tag may be coated with adhesive to allow easy bonding of the tag to an item of value, or to another component in order to form an object according to the invention.

Another alternative is that the tag is bonded to the item of value (or other component) using methods such as heat bonding. Since, in the embodiment shown in FIG. 8, the identification features are contained within a fairly thin section of the tag, if the tag is made of a thermoplastic polymer, such as polyethylene or polycarbonate for example, and the face 803 is used to heat-bond the tag to an item of value, it is extremely difficult to subsequently remove the tag without damaging or destroying the identification features. This provides for an excellent tamper-proofing feature to the tag since it would be extremely difficult to remove the tag from a genuine item and place it on a counterfeit.

FIG. 8c shows a cross-sectional view of a reader 810 adapted to read the tag or object shown in FIG. 8a. The reader 810 comprises at least a read element 811 and an engagement element 812 designed to engage the engagement track 802. An optional position tracking element 813 is also shown. In this embodiment the engagement element 812 protrudes from the rest of the reader, thereby allowing it to engage with the engagement track 802. Also in this embodiment, the engagement distance is typically at least 50 micrometers, and consequently the height of the engagement element 812 (given by dimension “Z”) is at least 50 micrometers and the depth of the engagement track 802 is also at least 50 micrometers. Also in order to engage easily, the width of the engagement element 812 (given by dimension “T”) is less than or equal to the width of the engagement track (given by dimension “Y”). In certain cases of this embodiment it may be advantageous to have width “T” greater than width “Y”, but in these cases either the engagement track or the engagement element must easily deform elastically so that meaningful engagement can still take place.

FIG. 9 shows a further embodiment of the invention. FIG. 9a shows a cross-sectional view of an identification tag 900 or object 900 adapted to be identified. The tag or object 900 contains identification features 901 that are arranged in an identification layer. FIG. 9a exemplarily shows identification layer with its thinnest dimension exposed, although it should be clear that also a main surface of the identification layer as illustrated in FIG. 8 can be equally used for reading the identification features. The tag further comprises an engagement track 902. In this embodiment the engagement track is designed as a recess (a groove, channel or slot) in the tag. The depth of the engagement track is given by dimension “Z” and its width by dimension “Y”. Unlike the embodiment shown in FIG. 8, the current embodiment highlights that the identification features need not be within or on the surface of the engagement track—in fact in some instances the identification features may be far away from the track. In the embodiment of FIG. 9, the identification features (or the identification layer) is arranged in the tag or object in a region positioned laterally to the recess that forms the engagement track. FIG. 9b shows a plan view of the tag or object shown in FIG. 9a. As shown in FIG. 9b the identification features (dimension “X”) may run the entire length of the engagement track—although as before, this is not necessary. One (or more) face 903 of the tag may be coated with an adhesive layer to allow easy bonding of the tag to an item of value, or to another component in order to form an object according to the invention. An alternative is that the tag is adapted so that it can be bonded to the item of value (or other component) using methods such as heat bonding.

FIG. 9c shows a cross-sectional view of a reader 910 adapted to read the tag or object shown in FIG. 9a. The reader 910 comprises at least a read element 911 and an engagement element 912 designed to engage the engagement track 902. An optional position tracking element 913 is also shown. In this embodiment the engagement element 912 protrudes from the rest of the reader, thereby allowing it to engage with the engagement track 902. The engagement distance is again typically at least 50 micrometers, and consequently the height of the engagement element 912 (given by dimension “Z”) is typically at least 50 micrometers and the depth of the engagement track 902 is typically also at least 50 micrometers. Also in order to engage easily, the width of the engagement element 912 (given by dimension “T”) should be less than or equal to the width of the engagement track (given by dimension “Y”).

FIG. 10 shows a further embodiment of the invention. FIG. 10a shows a cross-sectional view of a tag or object and FIG. 10b shows a plan view of the tag or object. The tag/object 1000 contains identification features 1001 arranged as an identification layer. In this case, the thinnest dimension of the identification layer is exposed, thereby forming a track for reading the identification features 1001. The tag or object further comprises an engagement track 1002. This embodiment is similar to the embodiments shown in FIG. 8 and FIG. 9. However, FIG. 10 illustrates a further variation of he positioning of the identification features 1001, where said variation can be produced by laminating the identification features in a sandwich structure to one side of the engagement track.

FIG. 10c shows a cross-sectional view of a reader 1010 adapted to read the tag or object shown in FIG. 10a. The reader 1010 comprises at least a read element 1011 and an engagement element 1012 designed to engage the engagement track 1002. An optional position tracking element 1013 is also shown.

FIG. 11 shows a further embodiment of the invention. FIG. 11a shows a cross-sectional view of a tag or an object adapted to be identified and FIG. 11b shows a plan view of the tag or the object. The tag/object 1100 contains identification features 1101 which are located in an identification layer. The thinnest dimension of said identification layer is exposed for reading the identification features. The tag/object 1100 can, alternatively or additionally, comprise identification features 1006 which are located in a layer of which a main surface is exposed for reading the identification features. The tag further comprises an engagement track 1102. This embodiment is similar to the embodiments shown in FIG. 8, FIG. 9 and FIG. 10. However FIG. 11 demonstrates that the engagement track need not have a rectangular cross sectional shape. Rather, the section can be any shape that allows for easy mechanical engagement—for example, the engagement track 1102 is formed as a protrusion that has a triangular section. The height of the engagement track is shown by dimension “Z”, while its width is given by dimension “Y”. The length of the identification features is given by dimension “X”.

FIG. 11c shows a cross-sectional view of a reader 1110 adapted to read the tag/object shown in FIG. 11a. The reader 1110 comprises at least a read element 1111 and an engagement element 1112 designed to engage the engagement track 1102 (for the sake of clarity, the reading element that is adapted to read the identification features 1106 is not shown in FIG. 11c). An optional position tracking element 1113 is also shown. The depth of the engagement element is given by dimension “D” while its width is given by dimension “T. Both “Z” and “D” are typically at least 50 micrometers. Since the engagement element and engagement track both have triangular cross-sectional shapes, the widths of each vary depending where they are measured. Here it was arbitrarily chosen to measure them at the base of the engagement track, which when engaged by the engagement element shown in this embodiment will be in a position corresponding to the opening of the engagement element—consequently it was chosen to show the width of the engagement element as the width at its opening. Clearly wherever the dimensions are measured it is important that once engaged, width “Y” must be less than or equal to width “T”, where “Y” and “T” are measured at corresponding positions during engagement.

FIG. 12 shows a further embodiment of the invention. FIG. 12a shows a cross-sectional view of a tag 1200 adapted to be embedded into an object of value, and the object of value. FIG. 12b shows a plan view of the tag embedded into the object of value. The tag 1200 contains identification features 1201. The tag has been embedded into an object of value 1204 and is further arranged within the object 1204 such that an engagement track 1202 is formed. In cross section, the engagement track has a trapezoidal shape. The embedding process can be done using any suitable means, for example the tag may be pushed into a plastic or metal item of value during a moulding or stamping process. An alternative, if the item of value softens upon heating (e.g. metals and thermoplastic polymers), is to push a heated tag into the item of value after it has been formed so that it melts the interface between the object and the tag and then the two parts adhere. A further alternative is for the item of value to be manufactured containing a groove or slot appropriate for the tag to fit into, then the tag is attached to the item of value using an adhesive. As these three alternatives demonstrate, there are many suitable ways to embed a tag into an object of value. As shown in FIG. 12a, the tag's engagement track has a depth of dimension “Z” and a width of dimension “Y”. The length of the identification features is given by dimension “X”.

FIG. 12c shows a cross-sectional view of a reader 1210 adapted to read the tag shown in FIG. 12a. The reader 1210 comprises at least a read element 1211 and an engagement element 1212 designed to engage the engagement track 1202. An optional position tracking element 1213 is also shown. The depth of the engagement element is given by dimension “D” while its width is given by dimension “T”. Also in this embodiment, both “Z” and “D” are typically at least 50 micrometers. As before, once engaged, width “Y” is less than or equal to width “T”, where “Y” and “T” are measured at corresponding positions during engagement.

FIG. 13 shows a further embodiment of the invention. FIG. 13a shows a cross-sectional view in the embedded state of a tag adapted to be embedded into an object of value, and the object of value. FIG. 13b shows a plan view of the tag embedded into the object of value. The tag 1300 contains identification features 1301. The tag has been embedded into an object of value 1304 such that it forms an engagement track 1302. As illustrated by the top view of FIG. 13b the recess can have a circular cross section, meaning that the engagement track is of cylindrical shape. As before, the embedding can be done using any suitable means. As shown in FIG. 13a, the tag's engagement track has a depth of dimension “Z” and a width of dimension “Y”. The length of the identification features is given by dimension “X”.

FIG. 13c shows a cross-sectional view of a reader 1310 adapted to read the tag shown in FIG. 13a or in FIG. 13b. The reader 1310 comprises at least a read element 1311 and an engagement element 1312 designed to engage the engagement track 1302. The depth of the engagement element is given by dimension “D” while its width is given by dimension “T” and the engagement element may have a cylindrical form. Both “Z” and “D” are again at least 50 micrometers. As before, once engaged, width “Y” is less than or equal to width “T”, where “Y” and “T” are measured at corresponding positions during engagement.

As said, this embodiment illustrates that the engagement track and engagement element can both be circular. The engagement element is designed to be inserted into the engagement track. Once engaged, the engagement element can be twisted to ensure that the read element is able to scan the identification information. Alternatively the engagement element may be kept still while the read element is actuated over the surface of the identification information. Alternatively, the read element may be able to read from the entire area containing the identification information without being moved (for example of the identification features are to be optically read, a 2D image (such as can be taken with a camera) may be sufficient to read the identification information.

An advantage of this approach of having the tag within a recess is that the tag is protected by the object, takes up little surface real estate, is obscured from being visually inspected (and perhaps copied or replicated) and this format makes the tag very difficult to tamper with, e.g. removing the tag and attaching it on another item.

FIG. 14 shows a further embodiment of the invention. FIG. 14a shows a cross-sectional view of a tag while FIG. 14b shows a view of one side of the tag. The tag 1400 contains identification features 1401. The tag further comprises an engagement track 1402. In this embodiment the engagement track is a rectangular-section cavity formed as a through-hole running along the length of the tag. Consequently when viewed from one side (as is shown in FIG. 14b) the tag appears hollow. The identification features are arranged in the tag such that they can be read by a read element comprised in the engagement element of a reading device where the engagement element is designed to be inserted into the cavity for reading the identification features. The identification features can, for example, be a barcode that is printed on a surface of the base layer of the tag before assembling the tag. Alternatively, the identification features may be randomly distributed particles (for example magnetic or optically active particles arranged in an identification layer. As shown in FIG. 14a and FIG. 14b, the tag's engagement track has a depth of dimension “Z” and cross-sectional dimensions of “Y” and “H”. The length of the identification features is given by dimension “X”.

FIG. 14c shows a cross-sectional view of a reader 1410 adapted to read the tag shown in FIG. 14a. The reader 1410 comprises at least a read element 1411 and an engagement element 1412 designed to engage the engagement track 1402. If a barcode is to read, the reading device may comprise an optical fibre which illuminates the section of barcode being read. The read element 1411 may be an optical detector such as camera or a regular bar code reading element. An optical fibre may also be used in the reading device, if randomly distributed fluorescent particles form the identification information. In this case, the optical fibre can emit light of the excitation wavelength of the fluorescent particles and the reading element 1411 can be a photodiode that is sensitive at the wavelength of the emitted fluorescent light. If magnetic particles form the identification information, a conventional magnetic read element can be used as reading element. The depth of the engagement element is given by dimension “D” while its width is given by dimension “T”. Also in this embodiment, both “Z” and “D” are typically at least 50 micrometers. As illustrated in FIG. 14c the engagement element can have an elongated form and for handling purpose may have a length in the millimetre or centimetre range. Once engaged, widths “Y” and “H” are less than or equal to widths “T” and “J” (not shown in FIG. 14, however, “J” is the width of the engagement element into the plane of the page). In this embodiment, the engagement element is designed to be inserted into the engagement track. Once engaged, the engagement element is withdrawn from the engagement track and the read element is able to scan the identification information. It will be clear having read some of the foregoing embodiments that scanning of the identification information by the read element could be done using a number of suitable means, e.g. imaging, actuation of the read element while the engagement element remains stationary, scanning upon engagement (rather than withdrawal), etc. FIG. 14c also shows an optional leaf spring 1415 which is positioned so as to ensure that the read element is kept in contact with the identification information during scanning.

The tag shown in FIG. 14 can be attached to an item of value via any of its faces, or can be embedded. Although FIG. 14 shows an embodiment where the hole is a rectangular-section through-hole, it will be appreciated that the hole can be any suitable cross-section (such as circular, elliptical, square, triangular, or multifaceted or partially curved) and can be a blind hole or any other suitable configuration. It is also understood that an object of interest can be rendered into object that is adapted to be identified by arranging the identification features in the object and forming the engagement track in the object.

FIG. 15 shows a further embodiment of the invention—in this embodiment either a tag comprising identification features is adapted to be embedded within an item of value or the object itself includes an identification layer in which identification features are located so that the object is adapted to be identified. Either the tag or the identification layer is arranged such in the object that an engagement track is formed. In the following, reference will only be made to the tag although the same comments also apply to an object that is adapted to be identified. FIG. 15a shows a tag 1500 before being embedded in the item of value. FIG. 15b shows the tag once embedded in an item of value 1504. The tag 1500 contains identification features 1501. The engagement track (which in this embodiment is a portion of the tag itself) is Y wide and Z tall. Here the dimension Z is measured as the height of the engagement track that is available to engage with the engagement element (after the tag is embedded) in order to allow the identification features to be read. The length of the identification features is given by dimension “X”.

FIG. 15c shows a cross-sectional view of a reader 1510 adapted to read the tag shown in FIG. 15b. The reader 1510 comprises at least a read element 1511 and an engagement element 1512 designed to engage the engagement track 1502. An optional position tracking element 1513 is also shown. The depth of the engagement element is given by dimension “D” while its width is given by dimension “T”. Both “Z” and “D” are typically at least 50 micrometers. The tag can be made from flexible material such as flexible polymer films, meaning it can as such be flexible.

While the tag is not being read, a further aspect of this invention is to provide for a cover such as a stopper, dust cap, surface membrane or spring loaded cover to prevent dirt, dust or other foreign objects entering the recess or the environment damaging or corroding the structure or the identification features.

In another embodiment of this invention, the reader is further modified to provide for an airflow into the recess to help dislodge and remove any debris that does enter the recess. This can be a blowing action before insertion or a sucking action that vacuum cleans the recess as it is inserted.

FIG. 16 shows one method for making a tag or an object such as the one shown in FIG. 14. First a precursor material 1601 is filled into cavity in an object 1600. The object 1600 can for example be a piece of a metal automotive component (for example a flange of a cast compressor or alternator housing) or it could be a garment accessory (e.g. a plastic button) or it could be any other item of value (or tag) suitable for comprising a cavity for identification purposes. The cavity can be formed in any suitable way. For example, it can be pre-existing (for example if the object is a section of tube stock, or a component which has the hole cast or forged into it) or it can be drilled into the object. The precursor material can be, for example, a polymeric resin such as an epoxy resin containing randomly dispersed magnetic particles, in which the magnetic particles have not been magnetized (this prevents them from clumping together within the precursor). FIG. 16a shows a cross-sectional view of the object after it has been filled with the precursor material. FIG. 16b shows an end view of the object after it has been filled with the precursor material. Once the precursor has been set (i.e. the curable polymer such as epoxy has been cured—using, for example, heat if the epoxy is a heat-curing epoxy) a rectangular slot 1602 running parallel to, but slightly offset from, the first cavity is drilled through the object. FIG. 16c shows a cross-sectional view of the object after the rectangular slot has been drilled. The rectangular slot forms the engagement track of the tag or the object. FIG. 16d shows an end view of the object after the slot has been drilled. Although a circular cavity and rectangular slot are shown in this embodiment, any suitable cavities/holes can used for an engagement track. Once the tag or the object has been formed the magnetic particles are magnetized by exposing the tag to a strong magnetic field, thereby forming the identification features.

FIG. 17 shows another tag or object of the invention containing a cavity as well as a method of making such a tag or an object containing a cavity. Also in this embodiment of a tag or object the tag's or objects identification information is read by inserting a reading element (or elements) into the cavity. Here the tag 1700 (shown in its final state in FIG. 17b) is formed by laminating an identification layer 1701 (i.e. a layer containing identification information, e.g. randomly dispersed material such as randomly dispersed magnetic or optical particles or fibers) between two pieces of material 1703 and 1704—the structure after lamination is shown in FIG. 17a. Thereafter a hole 1702 is drilled into the laminated structure. The hole forms the engagement track and runs parallel to the plane of the identification layer and cuts said layer in at least one place. FIG. 17c shows a cross-sectional view of a reading device 1710 adapted to read tag 1700. The reading device has two reading elements 1711 on either side of its engagement element 1712. The engagement element 1712 fits into the engagement track 1702 and the reading elements 1711 read the two sides of the identification layer that are exposed by the engagement track (i.e. the areas of the identification layer exposed when drilling the hole). In this embodiment of an identification tag or an object adapted to be identified, the thinnest dimension of the identification layer is exposed.

FIG. 18 shows another embodiment of a tag having a cavity as well as a corresponding method of making a tag containing a cavity. The tag's identification information is again read by inserting a reading element (or elements) into the cavity (using a reader similar to the reader shown in FIG. 14c). FIG. 18a shows a laminated piece 1807 comprising an identification layer 1801 laminated between two pieces of material 1803 and 1804. Piece 1807 is made using a similar method to that described regarding FIG. 17. Piece 1.807 is then embedded into material 1808, as shown in FIG. 18b. The formation of the tag 1800 (shown in FIG. 18c) is completed by drilling a hole 1802 into the material 1808. The hole 1802 shown in this case is a triangular-section hole running parallel to the plane of the laminated piece 1807. The hole cuts the laminated piece 1807, exposing an area of the identification layer. The hole 1802 forms the engagement track of the tag. An optional second set of identification features 1809 is shown on tag 1800—in this case the second set of identification features is a 1D barcode that can be used as additional information with which to identify the tag. The tag is read by inserting a suitably shaped engagement element (in this case a triangular section engagement element, although any section engagement element would be acceptable so long as the section is such that the element can be easily inserted in the cavity and it allows the read element to be accurately positioned with respect to the identification features) into the engagement track. The engagement element contains a reading element positioned so as to be able to read the exposed identification features as it is inserted or extracted from the engagement track.

FIG. 19 shows another tag of the invention containing a cavity as well as a method of making such a tag containing a cavity. The tag's identification information is read by inserting a reading element into the cavity (using a reader similar to the reader shown in FIG. 14c). FIG. 19a shows components of the tag prior to completing assembly of the tag. FIG. 19b shows the tag 1900 after it has been assembled. FIG. 19c shows the complete tag 1900 where the top piece has been made translucent to allow the assembled position of the various components to be seen. Here the identification features 1901 comprise a contact identification chip (such as found in smart cards) or a radio frequency identification (RFID) chip that requires close proximity to a reading element in order to be read (miniature RFID chips which have on-chip antennas—Hitatchi's μchip for example—require close proximity to a reading element in order to be read). The identification features 1901, i.e. the RFID chip or the contact identification chip, are mounted on a substrate 1903 as shown in FIG. 19a. Thereafter a top piece 1904 is bonded to the top of the substrate. The various components are designed in such a way that the complete tag 1900 after bonding as shown in FIGS. 19b and 19c will have a cavity 1902 which comprises the tags' identification track. The identification features 1901 are located such in a cavity that they can be accessed from the track. The reading device comprises an engagement element containing a reading element that is positioned so as to align with the identification features 1901 when the engagement element is inserted into the engagement track. This alignment facilitates the reading of the identification features. For example, in the case of a contact identification chip, reading of the chip requires that the input/output pads of the chip align with the corresponding output/input pads of the reading device—the current invention enables this alignment to take place easily and effectively. This kind of configuration can be used with other identification features, for example a 1D or 2D barcode where the engagement track ensures that the barcode reading element is correctly aligned to the barcode.

FIG. 20 shows a further embodiment of the invention. Here the tag 2000 (shown in cross-section) comprises an engagement track 2002 (in this case a rectangular-section blind hole) which has identification features 2001 located on at least one side of the track. The engagement track has one open end which is used to insert the reader's engagement element. As shown in FIG. 20, when the tag is not being read the engagement track can be closed with a stopper 2009. The configuration of having the engagement track as a cavity as shown in FIGS. 14, 16, 17, 18, 19 and 29 has the advantage that the identification features are well protected against wear and tear. If the engagement track is also closed by a stopper (as shown in FIG. 20), then the identification features can be even better protected against environmental factors. The stopper could, for example, take the form of a cap that can be screwed onto the tag thereby securing the stopper and preventing it from falling off. It is also contemplated that the stopper includes some form of tamper-evident function. For example, if it is in the form of a screw top, then the stopper can be designed in such a way that in order to open the stopper the user needs to break one part of the cap (methods for doing this are widely available in the literature and in fact most bottled goods with caps currently include this kind of feature). This means that it would be clear if the cap had been opened (and the tag potentially read and or tampered with) prior to when it was supposed to have been read.

FIGS. 21a and 21b show a further object according to the invention. This object comprises an identification tag, wherein said identification tag comprises an identification layer, wherein readable identification features are located in the identification layer of the identification. The identification tag is arranged in the object such that an engagement track is formed in the object by the object and the identification tag. The engagement track is essentially complimentary in shape to a part of a reading device that reads the identification features located in the identification layer via the reading track, the engagement track thereby allowing easy alignment of the reading device with the identification features.

FIG. 21a shows the object in cross-sectional view and FIG. 21b shows a plan view of the object. As said above, in this embodiment the object comprises a tag 2100 embedded into an item of value 2104. The tag contains identification features 2101 arranged in an identification layer. The engagement track 2102 is comprised of the lateral walls provided by the item of value and the base which is the surface of the tag itself.

FIG. 21c shows a cross-sectional view of a reader 2110 adapted to read the identification features of the object shown in FIG. 21a. The reader comprises at least one read element 2111 that is suited to reading the object's signature. For example, if the identification features comprise randomly distributed magnetic particles, the read element can also in this embodiment be a magnetic sensor such as a magnetic read head used, for example, in magnetic data storage tapes, VCRs, floppy discs or hard discs, whereas if the identification features comprised randomly dispersed optically emitting particles then the read element would be an optical sensor or optical detector). The read element is positioned a known fixed distance from one edge of protrusion 2112 that is designed to engage with the engagement track formed by the object and identification tag.

Also in this embodiment, where the engagement element is a protrusion, it is designed so that its width “T” is equal to or slightly less than the width of the engagement track “Y”, thereby allowing it to engage with the engagement track. In certain cases it may be advantageous to have width “T” greater than width “Y”, but in these cases either the engagement track or the engagement element must be deformable so that meaningful mechanical engagement can still take place. If needed, the reader may again include one or more position tracking elements 2113. For example if during reading the signature the reader is moved with respect to the object (or vice versa) to achieve repeatable readings it is in some circumstances important to accurately track the relative displacement between the object and reader, furthermore it may be advantageous to have at least a marking on the object to indicate the start point and/or end points where the readings should begin/end.

The position tracking element may, for example, be an optical position sensor such as those used in optical mice for computers. If the position sensor is used to identify the start and/or end points of the reading (and possibly position markings in between), then we have found an optical barcode sensor to work well. Clearly other sensors for sensing position are also acceptable, e.g. the sensor may be a magnetic sensor tracking magnetic markings/features designed to identify the position. Furthermore, it is sometimes advantageous to use a combination of more than one position sensor, for example a barcode sensor to identify the start and end points of the reading and an optical position sensor (such as used in a computer mouse) to track the distance moved between the markings.

FIG. 22 shows a further embodiment of the invention. FIG. 22a shows a cross-sectional view of the object. Also in this embodiment, the object forms an engagement track together with an identification tag that is included into the object. FIG. 22b shows a plan view of the object 2204. In this embodiment the object 2204 comprises a tag 2200 embedded into an item of value. The tag contains identification features 2201 (which are arranged within an identification layer of which the thinnest dimension is exposed). The engagement track 2202 is comprised of the lateral walls provided by the item of value and the base which is the surface of the tag itself. The embedding process can be done using any suitable means, for example the tag may be pushed into a plastic or metal item of value during a moulding or stamping process. An alternative, if the item of value softens upon heating (e.g. metals and thermoplastic polymers), is to push a heated tag into the item of value after it has been formed so that it melts the interface between the object and the tag and then the two parts adhere. A further alternative is for the item of value to be manufactured containing a groove or slot appropriate for the tag to fit into, then the tag is attached to the item of value using an adhesive. As these three alternatives demonstrate, there are many suitable ways to embed a tag into an object of value. As shown in FIG. 22a, the object's engagement track has a depth of dimension “Z” and a width of dimension “Y”. The length of the identification features is given by dimension

FIG. 22c shows a cross-sectional view of a reader 2210 adapted to read the tag shown in FIG. 22a. The reader 2210 comprises at least a read element 2211 and an engagement element 2212 designed to engage the engagement track 2202. An optional position tracking element 2213 is also shown. The depth of the engagement element is given by dimension “D” while its width is given by dimension “T”. Both “Z” and “D” are typically at least 50 micrometers in this embodiment as well. Once engaged and as explained in context with previously described embodiments, width “Y” must be less than or equal to width “T”, where “Y” and “T” are measured at corresponding positions during engagement.

FIG. 23 shows a further embodiment of the invention. FIG. 23a shows a cross-sectional view of the object. The object 2300 comprises a region 2304 which contains identification features 2301 (that are typically arranged in an identification layer). The object further comprises an engagement track 2202. In this embodiment the engagement track is a recess shaped as a groove, channel, or slot in the object. The depth of the engagement track is given by dimension “Z” and its width by dimension “Y”. FIG. 23b shows a plan view of the object shown in FIG. 23a. As shown in FIG. 23b the identification features (dimension “X”) may run the entire length of the engagement track—although as before, this is nor necessary,

FIG. 23c shows a cross-sectional view of a reader 2310 adapted to read the object shown in FIG. 23a. The reader 2310 comprises at least a read element 2311 and an engagement element 2312 designed to engage the engagement track 2302. An optional position tracking element 2313 is also shown. In this embodiment the engagement element 2312 protrudes from the rest of the reader, thereby allowing it to engage with the engagement track 2302. The engagement distance is again typically at least 50 micrometers, and consequently the height of the engagement element 512 (given by dimension “Z”) is usually at least 50 micrometers and the depth of the engagement track 502 is also at least 50 micrometers. Also in order to engage easily, the width of the engagement element 512 (given by dimension “T”) should be less than or equal to the width of the engagement track (given by dimension “Y”). In certain cases it may be advantageous to have width “T” greater than width “Y”, but in these cases either the engagement track or the engagement element must easily deform elastically so that meaningful engagement can still take place.

FIG. 24 shows a further embodiment of the invention. FIG. 24a shows a cross-sectional view of an object 2400. The object 2400 comprises a region 2404 which contains identification features 2401. The object further comprises an engagement track 2402. In this embodiment the engagement track is a ridge in the object. The height of the engagement track is given by dimension “Z” and its width by dimension “Y”. The embodiment of FIG. 24 highlights again that the identification features need not be within or on the surface of the engagement track—in fact in some instances the identification features may be far away from the track, for example, arranged in a surface lateral or adjacent to the engagement track. FIG. 24b shows a plan view of the object shown in FIG. 14a. As shown in FIG. 24b the identification features (dimension “X”) may run the entire length of the engagement track—although as before, this is not necessary.

FIG. 24c shows a cross-sectional view of a reader 2410 adapted to read the object shown in FIG. 24a. The reader 2410 comprises at least a read element 2411 and an engagement element 2412 designed to engage the engagement track 2402. An optional position tracking element 2413 is also shown. In this embodiment the engagement element 2412 is a slot, thereby allowing it to engage with the engagement track 2402. The engagement distance is usually again at least 50 micrometers, and consequently the depth of the engagement element 2412 (given by dimension “Z”) is usually also at least 50 micrometers and the height of the engagement track 2402 is usually also at least 50 micrometers. Also in order to engage easily, the width of the engagement element 612 (given by dimension “T”) should be greater than or equal to the width of the engagement track (given by dimension “Y”).

FIG. 25 shows a further embodiment of the invention. FIG. 25a shows a cross-sectional view of an object while FIG. 25b shows a view of one side of the object. The object 2500 comprises a region 2504 which contains identification features 2501. The object further comprises an engagement track 2502. In this embodiment the engagement track is a rectangular-section through-hole running along the length of the object. Consequently when viewed from one side (as is shown in FIG. 25b) the object appears hollow. As shown in FIG. 25a and FIG. 25b, the object's engagement track has a depth of dimension “Z” and cross-sectional dimensions of “Y” and “H”. The length of the identification features is given by dimension “X”. The identification features in the object 2500 can be read with a reader as shown in FIG. 14c.

FIG. 26 shows a further embodiment of the invention; a cross-sectional view of an object according to the invention is shown. The object comprises a tag 2600 attached to an item of value 2604. The tag contains identification features 2601. When the tag is attached to the item of value to form the object, the combined unit forms an engagement track 2602—in this case a cavity between the tag and item of value. The top and side walls of the cavity are formed from the tag and its bottom wall is formed from the item of value. The object can be read using a suitable reader of similar form to the one shown in FIG. 14c.

FIG. 27 shows a further embodiment of the invention; a cross-sectional view of an object according to the invention is shown. The object comprises a tag 2700 attached to an item of value 2704. The item of value contains identification features 2701. When the tag is attached to the item of value to form the object, the combined unit forms an engagement track 2702—in this case a cavity between the tag and item of value. The top and side walls being of the cavity are formed from the tag and its bottom wall is formed from the item of value. The object can be read using a suitable reader of similar form to the one shown in FIG. 14c.

FIG. 28 shows a further embodiment of the current invention. FIG. 28a shows an object 2800 according to the current invention. The object is made by laminating an identification layer 2801 between two sheets of material 2803 and 2805. Also sandwiched in the laminated structure is an object of value 2804. After lamination a key-hole shaped slot is drilled, punched or cut through the laminate structure. The key hole comprises a round entry hole 2808 and an engagement track 2802. The identification layer is exposed along the sides of the sides of the engagement track 2802. Here as well as within the entire specification the term “exposed” means “accessible to be meaningfully read using an appropriate reading device”, it does not necessarily mean that the identification layer (or identification information) is directly exposed to the environment—for example, the structure could comprise a protective layer that coats the “exposed” area of the identification information. Provided that the protective layer allows the identification features to be meaningfully read by an appropriate reading device the identification information is considered exposed. As with the other embodiments in this invention, the identification features can comprise any device-readable feature. For example, when the identification layer comprises a piece of paper or fabric, a reader can be used identify the relative positions of the fibres of the paper or fabric exposed by the track. Methods for mapping these kinds of identification features are well known in the literature, see for example United Kingdom patent application number GB 2 417 707 describes the use of laser speckle to uniquely identify paper using its fibre as a fingerprint (the application also describes other means of using fibres in paper and other materials as unique identifiers).

FIG. 28b shows a cross-sectional view of a reading device that is adapted to read tag 2800 shown in FIG. 28a. The reading device comprises at least one read element 2811 (in the figure two are shown) arranged so as to be able to read the identification features as the reader's engagement element 2812 is moved along the tag's engagement track 2802. In this embodiment the engagement element is inserted into the entry hole 2808 before being moved laterally to fully engage with the engagement track, thereby aligning the read element/s with the identification features.

The configuration shown in FIG. 28a is particularly well suited to being used for fabrics and other flexible or thin objects of value. If, for example, the item of value is a piece of paper, it may be possible to use the fibres of the paper itself as the identification features. This would mean that the identification layer 2801 is not needed and the object can exist without it, since the paper itself would form the identification layer necessary to identify the object.

Next, examples of identification layers that can be used in objects or tags of the invention methods and examples of methods of making such identification layer are further illustrated

FIG. 29a shows the formation of an identification layer 2900 (which can thus also be called a one-layer tag) which can be used in tags or objects of the invention. Here magnetic or magnetizable particles 2901 are mixed with a non-magnetic matrix material 2902 (this matrix material can be, but is not limited to, a polymer or metal). The mix flows from a hopper 2903 down a pipe 2904 and is extruded and/or rolled using an extruding/rolling mechanism 2905. An isometric view of the resulting identification layer is shown in FIG. 29b. In this case the identification layer 2900 (with dimensions a, b, c) can be sufficiently robust so as not to require supporting layers on either the top or bottom surface. Therefore, it is also noted in this context, that the identification layer 2900 can also be turned into a “cavity tag” of the invention as exemplified in FIG. 16 provided that the layer has a thickness and stability sufficient to form a cavity therein. Furthermore the layer could be used as the insert in FIG. 18. It should also be noted that also a recess can be formed in the layer so that the layer could also be rendered into a “recess tag” as described here. It is also again noted that both the thinnest dimension of the layer, for example along the direction b can be used for reading the identification features and a main surface that is in the b-c plane of the layer 2900 can be used for reading the identification features.

Next, referring to FIG. 30A to FIG. 30H, views during a method for manufacturing embodiments of identification tags or an object adapted to be identified will be described.

FIG. 30A to FIG. 30D show a process which may be used to produce such tags or objects. Firstly, as shown in FIG. 30A, nickel flakes 3000 are brushed onto the glue containing side of a polymeric laminating sheet 3001. Then, as shown in FIG. 30B, another laminating sheet 3002 is overlaid and the stack of material is laminated together by passing the stack through a conventional office-stationary laminator at 110° C. and the lowest preset speed. So doing, a tag or object 3010 (shown in unassembled state in FIGS. 30B and 30F) containing identification features is obtained. If appropriate, the edge cross-section is then polished to ensure that a smooth surface containing a reading track 3003 of the identification layer is exposed, as shown in FIG. 30C. Either a main surface or the edge exposing reading track 3003 can then be read using a magnetic field sensor to provide a fingerprint/signature 3004, as shown in FIG. 30D, in which the particles cause peaks in the magnetic field that then coincide with peaks in the fingerprint/signature. Suitable magnetic field sensors include inductive heads, AMR heads, GMR heads and magneto optical Kerr effect detectors. The process for manufacturing embodiments of identification tags or objects adapted to be identified illustrated in FIG. 30F to FIG. 30H is identical to the one of FIG. 30A to FIG. 30D with the exception that elongated nickel flakes or fibres or whiskers that are arranged in the plane of the identification layer are used. Because of the different size, shape and arrangement of the nickel flakes, the fingerprint 3004 that is obtained from reading the track is of course different from the one in FIG. 30D. The elongated shapes give the added advantage that the magnetic signal detected from the track is a substantially out-of-plane magnetic signal, making the signal easier to detect (and hence the fingerprint easier to read) and the tag even harder to forge. A structure 3010 shown in FIG. 30 can for example be then included into an object of value to form an engagement track within the object (cf. FIG. 4, for example) or can be included such in the object that it forms the engagement together with the object (cf. FIG. 21 and FIG. 22, for example) or can be rendered into a cavity tag as shown in FIG. 17 or included into a tag or object as shown in FIG. 18.

Although this invention has been described in terms of preferred embodiments, it has to be understood that numerous variations and modifications may be made, without departing from the spirit and scope of this invention as set out in the following claims.

1-232. (canceled)

233. An identification tag for identifying an object to which the identification tag may be attached, said identification tag comprising a cavity,
wherein readable identification features are arranged such in the tag that the identification features can be read by a part of a reading device to be inserted into the cavity for reading the identification features,
wherein the cavity is designed such that an engagement track is formed in the tag, and
wherein said engagement track is essentially complimentary in shape to the part of the reading device that reads the identification features arranged in the tag, the engagement track thereby allowing easy alignment of said part of the reading device with respect to the identification features.

234. An object having attached an identification tag as defined in claim 233.

235. An object adapted to be identified, wherein said object comprises a cavity,
wherein readable identification features are arranged such in the object that the identification features can be read by a part of a reading device to be inserted into the cavity for reading the identification features,
wherein the cavity is designed such that an engagement track is formed in the object, and
wherein said engagement track is essentially complimentary in shape to the part of the reading device that reads the identification features arranged in the object, the engagement track thereby allowing easy alignment of said part of the reading device with respect to the identification features.

236. An identification tag for identifying an object to which the identification tag may be attached, said identification tag comprising an identification layer,
wherein readable identification features are located in the identification layer and wherein said identification features are at least partly formed by randomly distributed material comprised in the identification layer, and
wherein the identification layer is arranged in the identification tag such that an engagement track is formed in the tag, wherein said engagement track is essentially complimentary in shape to a part of a reading device that reads the identification features located in the identification layer, the engagement track thereby allowing easy alignment of said part of the reading device with respect to the identification features.

237. An object having attached an identification tag as defined in claim 236.

238. An object adapted to be identified, wherein said object comprises an identification layer,
wherein readable identification features are located in the identification layer and wherein said identification features are at least partly formed by randomly distributed material comprised in the identification layer, and
wherein the identification layer is arranged in the object such that an engagement track is formed in the object, wherein said engagement track is essentially complimentary in shape to a part of a reading device that reads the identification features located in the identification layer, the engagement track thereby allowing easy alignment of the reading device with respect to the identification features.

239. An object comprising an identification tag, wherein said identification tag object comprises an identification layer,
wherein readable identification features are located in the identification layer of the identification tag and wherein said identification features are at least partly formed by randomly distributed material comprised in the identification layer, and,
wherein the identification tag is arranged in the object such that an engagement track is formed by the object and the identification tag, wherein said engagement track is essentially complimentary in shape to a part of a reading device that reads the identification features located in the identification layer via the reading track, the engagement track thereby allowing easy alignment of the reading device with respect to the identification features.

240. An object having attached an identification tag, wherein said identification tag object comprises an identification layer,
wherein readable identification features are located in the identification layer and wherein said identification features are at least partly formed by randomly distributed material comprised in the identification layer, and
wherein the identification tag is arranged on an external surface of the object such that the tag forms an engagement track on the object, wherein said engagement track is essentially complimentary in shape to a part of a reading device that reads the identification features located in the identification layer via the reading track, the engagement track thereby allowing easy alignment of the reading device with the identification features,
with the proviso that the identification layer is not exposed in such a manner that at least some of the readable identification features are only meaningfully readable from the thinnest dimension of the identification layer.

241. A reading device for reading identification features that are located in an identification tag or an object adapted to be identified, wherein the identification tag or object comprises an engagement track formed as a cavity or recess in the tag or the object, wherein said engagement track is used to read the identification features,
said reading device comprising
a reading element adapted for reading the identification features located in the identification tag or object adapted to be identified, wherein said reading element is located within an engagement element of the reading device, wherein said engagement element is essentially complementary in shape to the engagement track of the identification tag or object.

242. A reading device for reading identification features that are located in an identification tag or an object adapted to be identified, wherein the identification tag or object comprises an engagement track formed as a protrusion in the tag or the object, wherein said engagement track is used to read the identification features,
said reading device comprising
a reading element adapted for reading the identification features located in the tag or object, wherein the reading element is located in a non-U-shaped engagement element that is essentially complementary in shape to the engagement track of the identification tag or object.

243. A reading device for reading identification features that are located in an identification tag or an object adapted to be identified, wherein the identification tag or object comprises an engagement track formed as a protrusion in the tag or the object, wherein said engagement track is used to read the identification features,
said reading device comprising
an engagement element having a recess that is essentially complementary in shape to the engagement track of the identification tag or object, wherein the engagement element comprises in a lateral region of the recess a reading element adapted for reading the identification features located in the identification tag.
